(19) United States
(12) Patent Application Publication
(10) Pub. No.: US 2024/0022152 A1
(43) Pub. Date: Jan. 18, 2024

(54) Resonance-Enabled Machines

(71) Applicants: Peter Andrew LUCON, Butte, MO (US); Lucon Engineering, Inc., Butte, MT (US)

(72) Inventors: Peter Andrew Lucon, Butte, MT (US); Doran John Michels, Moab, UT (US); Beauford Eugene Munson, Butte, MT (US); Michael James Paffhausen, Butte, MT (US); Robert James Hall, Butte, MT (US)

(73) Assignee: Lucon Engineering, Inc., Butte, MT (US)

(21) Appl. No.: 18/247,636

(22) PCT Filed: Oct. 8, 2021
(86) PCT No.: PCT/US21/54112

§ 371 Date: Mar. 31, 2023

Related U.S. Application Data
(60) Provisional application No. 63/089,509, filed on Oct. 8, 2020.

(51) Int. Cl. H02K 33/02; H02K 7/14

(52) U.S. Cl. CPC H02K 33/02; H02K 7/14

(57) ABSTRACT

Provided herein are resonance-enabled machines, comprising one or more voice coil actuators mounted on a non-moving mass, such as a housing, one or more moving masses, and one or more pluralities of springs coupling the non-moving mass to the one or more moving masses. One or more of the moving masses can perform a specific task. For example, the moving mass may drive a pump as a vacuum pump or a compressor. The moving mass may drive a hammer chisel, for example, to break or fracture structures. The moving mass may drive a device to consolidate, for example, soil. The moving mass may impact a member to drive the member into another member, such as a pile into the soil. Each moving mass may be coupled to a voice coil actuator, and the machine is an electrical-mechanical-electrical transformer.

This application claims the benefit of priority of U.S. Provisional Patent Application Ser. No. 63/089,509 filed Oct. 8, 2020, the disclosure of which is incorporated by reference in its entirety for all purposes.

The present disclosure generally relates to machines that use resonance to transfer energy to a workpiece and related methods.

Vibrators, vacuum pumps, compressors, jackhammers, pile drivers, and soil compactors are notoriously inefficient, loud, and vibrate. Previous attempts to use resonance-enabled machines to reduce this noise and vibration have been unsuccessful, partly because the systems were only partially resonant and relied only upon the piston pressure for the spring, which is non-linear and subject to loss.

Furthermore, power transformers have relied on induction to reduce output voltages for end-users. But efficiency falls off considerably at moderate to light loads. And these transformers offer essentially no protection against surges and electromagnetic pulses, a vulnerability for terrorist attacks and solar mass ejections.

The resonance-enabled machines disclosed herein solve these problems by providing more efficient machines, saving money, and making power loads on the machines easier to meet. In several embodiments, two or masses move out of phase of one another and are tunable to the needs of the workpiece. In addition, spring rates are sized to reduce the net force to or near zero transmitted through the frame and ultimately to the ground or in some cases and operator.

### SUMMARY

The present disclosure provides a resonance-enabled machine comprising one or more voice coil actuators mounted on a non-moving mass, one or more moving masses, and one or more resilient members coupling the non-moving mass to the one or more moving masses.

The present disclosure further provides resonance-enabled vibrator, comprising a housing; a first moving mass coupled to the housing by the first plurality of resilient member; a coil assembly disposed on and coupled to the housing; and a voice coil magnet assembly coupled to the moving mass.

The present disclosure also provides a resonance-enabled vacuum pump, comprising a housing; a voice coil actuator comprising a coil assembly rigidly disposed on the housing and a magnet assembly; a first moving mass rigidly coupled to the magnet assembly, further coupled to the housing by a plurality of housing-to-first moving mass springs, and further coupled to a second moving mass by a plurality of first moving mass to second moving mass springs; and a first pump disposed on the housing and coupled to the first moving mass by a first barrel.

The present disclosure provides a resonance-enabled jackhammer, comprising a housing; a voice coil actuator comprising a coil assembly rigidly disposed on the housing and a magnet assembly; a first moving mass rigidly coupled to the magnet assembly, further coupled to the housing by a plurality of housing-to-first moving mass springs, and further coupled to a second moving mass by a plurality of first moving mass to second moving mass springs; and a hammer chisel rigidly coupled to the first or second moving mass.

The present disclosure provides a resonance-enabled pile driver, comprising a housing; a voice coil actuator comprising a coil assembly rigidly disposed on the housing and a magnet assembly; a first moving mass rigidly coupled to the magnet assembly, further coupled to the housing by a plurality of housing-to-first moving mass springs, and further coupled to a second moving mass by a plurality of first moving mass to second moving mass springs; and an anvil rigidly coupled to the first or second moving mass.

The present disclosure provides a resonance-enabled soil compactor, comprising a housing; a voice coil actuator comprising a coil assembly rigidly disposed on the housing and a magnet assembly; a first moving mass rigidly coupled to the magnet assembly, further coupled to the housing by a plurality of housing-to-first moving mass springs, and further coupled to a second moving mass by a plurality of first moving mass to second moving mass springs; and a tamping plate rigidly coupled to the first or second moving mass.

The present disclosure provides a resonance-enabled transformer, comprises a housing; a first voice coil actuator comprising a first magnet assembly and a first coil assembly rigidly disposed on the housing at a primary winding; a second coil actuator comprising a second magnet assembly and a second coil assembly rigidly disposed on the housing at a secondary winding; a first moving mass rigidly coupled to the first magnet assembly, further coupled to the housing by a plurality of housing-to-first moving mass springs, and further coupled to a second moving mass by a plurality of first moving mass to second moving mass springs.

### BRIEF DESCRIPTION OF THE DRAWINGS

The disclosure will be readily understood by the following detailed description in conjunction with the accompanying drawings, wherein like reference numerals designate like structural elements. The drawings provide exemplary embodiments or aspects of the disclosure and do not limit the disclosure's scope.

FIG. 1 shows a resonance-enabled machine configured as a vibrator.

FIG. 2 shows a top perspective cross-section of a resonance-enabled vibrator.

FIG. 3 shows a side plan view of the resonance-enabled vibrator of FIG. 2.

FIG. 4 shows a second side plan view of the resonance-enabled vibrator of FIG. 2.

FIG. 5 shows a third side plan view of the resonance-enabled vibrator of FIG. 2.

FIG. 6 shows a top plan view of the resonance-enabled vibrator of FIG. 2.

FIG. 7 shows a resonance-enabled vibrator with two voice coil actuators coupled on the same side of a moving mass.

FIG. 8 shows a resonance-enabled vibrator with two voice coil actuators coupled on opposite sides of a moving mass.

FIG. 9 shows a resonance-enabled vacuum pump/compressor comprising a voice coil actuator, one moving mass, and one pump head.

FIG. 10 shows a resonance-enabled vacuum pump/compressor comprising a voice coil actuator, two moving masses, and two pump heads.

FIG. 11 shows a resonance-enabled vacuum pump/compressor comprising a voice coil actuator, two moving masses, and four pump heads.

FIG. 12 shows a resonance-enabled vacuum pump/compressor comprising two voice coil actuators, two moving masses, and two pump heads, where both voice coil actuators are coupled to the first moving mass.

FIG. 13 shows a resonance-enabled vacuum pump/compressor comprising two voice coil actuators, two moving masses, and two pump heads. The first voice coil actuator is coupled to the first moving mass, and the second voice coil actuator is coupled to the second moving mass.

FIG. 14 shows a resonance-enabled machine configured as a jackhammer or demolition hammer, comprising one voice coil actuator and two moving masses.

FIG. 15 shows a resonance-enabled machine with a spring-damper configured as a hammer/chisel.

FIG. 16 shows a resonance-enabled machine configured as a pile driver, post pounder, or hammer, comprising one voice coil actuator and two moving masses.

FIG. 17 shows a resonance-enabled machine configured as a pile driver, post pounder, or hammer, comprising two voice coil actuators coupled to the housing to each of two moving masses.

FIG. 18 shows a resonance-enabled machine configured as a pile driver, post pounder, or hammer, comprising two voice coil actuators coupled to the housing and to the first of two moving masses.

FIG. 19 shows a resonance-enabled machine configured as a pile driver, post pounder, or hammer, comprising a voice coil actuator coupled between two moving masses.

FIG. 20 shows a resonance-enabled machine with a spring-damper configured as a pile driver, post pounder, or hammer.

FIG. 21 shows a resonance-enabled soil compactor with one voice coil actuator and two moving masses.

FIG. 22 shows a resonance-enabled soil compactor comprising two voice coil actuators between two masses.

FIG. 23 shows a resonance-enabled soil compactor comprising multiple voice coil actuators on opposite sides of two moving masses.

FIG. 24 shows a resonance-enabled machine with a spring-damper configured as a soil compactor.

FIG. 25 shows a resonance-enabled machine with a spring-damper configured as a tamper.

FIG. 26 shows another resonance-enabled machine with a spring-damper configured as a tamper.

FIG. 27 shows a resonance-enabled single-phase transformer comprising a fixed voice coil bobbin at the supply side/primary winding (electrical line input), a fixed coil bobbin at the load side/secondary winding output, and two moving masses.

FIG. 28 shows the second coil assembly, comprising two independently wrapped coils, the first coil, and the second coil.

FIG. 29 shows the cross-section of the second magnet assembly.

FIG. 30 shows the cross-section of another embodiment of the second magnet assembly.

FIG. 31 shows the potential energy and kinetic energy changes of a single-phase transformer of FIG. 27 as a function of time.

FIG. 32 shows the energy when the resonance-enabled transformer of FIG. 27 operates at a frequency below mechanical resonance.

FIG. 33 shows a resonance-enabled single-phase transformer that matches the input voltage to the output voltage.

FIG. 34 shows the Bode plot in oscillatory velocity amplitude (inches/second) as a function of frequency (Hz), including the amplitude or magnitude and phase of the first moving mass and the second moving mass. The operating point is set at 60 Hz.

FIG. 35 shows the Bode plot in-phase (degrees) as a function of frequency (Hz), including the amplitude or magnitude and phase of the first moving mass and the second moving mass. Again, the operating point is set at 60 Hz.

FIG. 36 shows an electrical-mechanical-electrical transformer comprising a supply side/primary winding, a load side/secondary winding, and three voice coil actuators

FIG. 37 shows a resonance-enabled three-phase transformer.

FIG. 38 shows delta-delta and delta-wye transformer configurations for the resonance-enabled three-phase transformer of FIG. 37.

FIG. 39 shows a measurement system compatible with a resonance-enabled machine disclosed herein.

Table 1 lists references numerals used throughout the figures and this disclosure.

TABLE 1
Reference numerals

| | |
|---|---|
| 105 | energy |
| 110 | first pump |
| 116 | barrel |
| 120 | second pump |
| 126 | second barrel |
| 200 | moving/oscillating masses |
| 205 | mass kinetic energy |
| 210 | first moving/oscillating mass |
| 215 | motion of first moving/oscillating mass |
| 220 | second moving/oscillating mass |
| 225 | motion of second moving/oscillating mass |
| 230 | third moving/oscillating mass |
| 240 | fourth moving/oscillating mass |
| 250 | fifth moving/oscillating mass |
| 260 | sixth moving/oscillating mass |
| 300 | housing/non-moving mass |
| 310 | first housing plate |
| 312 | housing ledge |
| 320 | second housing plate |
| 330 | housing shell |
| 350 | standoff |
| 351 | fastener |
| 400 | springs |
| 405 | spring potential energy |
| 410 | housing-to-first moving mass springs |
| 420 | second moving mass-to-housing spring |
| 430 | first moving mass-to-second moving mass spring |
| 440 | housing-to-third moving mass springs |
| 450 | fourth moving mass-to-housing spring |
| 460 | third moving mass-to-fourth moving mass spring |
| 470 | housing-to-fifth moving mass springs |
| 480 | sixth moving mass-to-housing spring |
| 490 | fifth moving mass-to-six moving mass spring |
| 500 | voice coil actuator |
| 510 | first coil assembly |
| 515 | first magnet assembly |
| 520 | second coil assembly/fixed coil bobbin |
| 525 | second magnet assembly |
| 530 | third coil assembly |
| 535 | third magnet assembly |
| 540 | fourth coil assembly |
| 545 | fourth magnet assembly |
| 550 | fifth coil assembly |
| 551 | supply side/primary winding |
| 552 | load side/secondary winding |
| 553 | center tap/ground/neutral |
| 554 | secondary first line voltage |
| 555 | fifth magnet assembly |
| 556 | secondary second line voltage |
| 558 | secondary third line voltage |
| 560 | sixth coil assembly |
| 565 | sixth magnet assembly |
| 576 | first magnet |
| 577 | second magnet |
| 578 | first spacer |
| 579 | second spacer |
| 580 | magnet housing |
| 581 | magnetic field |
| 590 | bobbin |
| 600 | hammer chisel |
| 610 | anvil |
| 620 | adapter sleeve |
| 630 | weights |
| 640 | weights clamp |
| 650 | tamping plate |
| 655 | motion of tamping plate |
| 660 | coupler |
| 700 | workpiece |
| 710 | media |
| 720 | pile |
| 725 | impact area |
| 730 | soil |
| 735 | impact area |
| 740 | baseplate/soil compaction plate |
| 741 | first wall |
| 742 | second wall |
| 750 | damper |
| 755 | spring-damper |
| 760 | guide |
| 761 | first guide |
| 762 | second guide |
| 763 | third guide |
| 764 | fourth guide |
| 800 | ground |
| 810 | input voltage |
| 820 | output voltage |
| 900 | measurement system |
| 910 | power source |
| 920 | motion sensor |
| 930 | current sensor |
| 940 | voltage sensor |
| 950 | amplifier |
| 960 | function generator |
| H₁ | first primary wire |
| H₂ | second primary wire |
| k₁ | first spring constant |
| k₂ | second spring constant |
| k₃ | third spring constant |
| k₄ | fourth spring constant |
| k₅ | fifth spring constant |
| k₆ | sixth spring constant |
| k₇ | seventh spring constant |
| k₈ | eighth spring constant |
| k₉ | ninth spring constant |
| X₁ | first secondary wire |
| X₂ | second secondary wire |

### DETAILED DESCRIPTION

Generally, the resonance-enabled machines disclosed herein comprise one or more pluralities of springs 400 and one or more moving masses 200 arranged to cancel out the resultant motion forces to the ground. Some embodiments capitalize on transmitting the motion forces to the housing and, ultimately, to the machine's structure.

In certain embodiments, the non-moving mass is a housing, and the voice coil assembly is mounted to the housing, so the lead wires to the coil do not move or fatigue. All known prior systems are non-resonant and move the voice coil because it is lighter than the magnet assembly. This arrangement provides the highest performance possible. Using a resonance-enabled machine, the mass's kinetic energy is balanced with the springs' potential energy. Therefore, performance is no longer tied to the moving mass (oscillating mass), enabling the heavier component of the voice coil assembly to be directly coupled to the moving assembly.

The resonance-enabled machine operates on or near resonance, conserving energy within the machine by balancing the potential and kinetic energies. Once the machine is charged with energy, it moves the energy back and forth between potential and kinetic energy. As a result, machine losses are minimal with metallic springs (such as steel alloys) and the air resistance of the moving masses.

The housing does not vibrate to the same degree as prior systems. As a result, less frequent scheduled maintenance is needed, ultimately increasing reliability and decreasing expenses.

The sound generation operates at a safer decibel level for the user than prior systems driven by internal combustion engines. Therefore, the disclosed systems contribute less noise pollution to the surrounding areas. In addition, the machine's weight uses smaller batteries than prior battery-operated machines because of the efficiency, making the machine more portable and ergonomic for users.

The present disclosure provides a resonance-enabled machine, comprising one or more voice coil actuators each comprising a coil assembly and a magnet assembly, a non-moving mass rigidly coupled to the one or more coil assemblies, one or more moving masses rigidly coupled to the one or more magnet assemblies, and one or more springs coupling the non-moving mass to the one or more moving masses.

In certain embodiments, the resonance-enabled machine further comprises a spring-damper. The spring-damper, when present, has both spring and damper properties. For example, in certain embodiments, the spring-damper comprises rubber, having a stiffness and viscoelastic properties. In certain other embodiments, the spring-damper has a very small viscoelastic portion near zero.

In certain embodiments, the spring-damper is a pocket of air. In certain embodiments, the spring-damper is rigidly coupled to the machine. In certain embodiments, the spring-damper is rigidly coupled on one end to the machine, thereby permitting intermittent contact with the other end. In certain embodiments, the spring-damper is rigidly coupled on both ends to the machine.

### Voice Coil

Provided herein is a voice coil configured to enable many devices for various applications in resonance-enabled machines. These devices and resonance-enabled machines are described further in embodiments below.

A voice coil actuator commonly drives mechanical systems with linear motion. The coil assembly is disposed on the moving mass because it is lighter than the magnet assembly and losses from the inertia of the oscillating mass prevent the heavier mass from being the moving mass. Examples include loudspeakers to generate sound/music. Care has been taken to reduce the coil assembly's weight mounted to the speaker to provide the best performance with the highest efficiency.

With the coil moving, power wires delivering current to the coil are constantly fatigued, limiting the life for the voice coil and the power wires delivering current to the coil. As disclosed herein, the voice coil is mounted to a non-moving mass (e.g., housing) to mitigate fatigue and reliability. Still, up to now, this configuration has caused reduced performance and lower efficiency. By configuring the voice coil assembly in a resonance-enabled machine, the kinetic energy stored in the machine by the voice coil assemblies' moving masses is directly offset by potential energy stored within the machine's springs. Therefore, heavier voice coil assemblies can be mounted on one of the one or more moving masses of the resonance-enabled machine without losing performance or efficiency.

In some embodiments, the forces are not transmitted to the housing. Rather, the machine performs different tasks, with little to no force transferred to the housing. These configurations use multiple oscillating moving masses. The machine comprises a voice coil actuator, a first moving mass, a second moving mass, and a housing. The voice coil actuator comprises both a coil assembly and a magnet assembly. The coil assembly is mounted on the housing or a mass with no or small movements compared with the moving masses. The magnet assembly is mounted on either of the moving masses.

The moving masses are configured to operate on a resonant mode shape. The moving masses are out of phase of one another. Each mass is coupled to the housing through a spring. The masses are also coupled with each other through springs. The machine is configured so that the forces transferred to the housing through the coupling springs between the moving masses and the housing are at or near zero over the machine's operating range around its resonant frequency. The housing may be further coupled to a machine through another spring to further decrease the forces transmitted to the ground.

In certain embodiments, the resonance-enabled machine has a resonance frequency, and when the machine is in resonance, the input driving force is in phase with the oscillating velocity of the one or two masses.

In certain embodiments, one or both of the moving masses performs a specific task. In one embodiment, the one or more moving masses drive a pump as a vacuum pump or a compressor. In another embodiment, the one or more moving masses drive a hammer chisel, for example, to break or fracture structures. In another embodiment, the one or more moving masses drive a device to consolidate. In another embodiment, the one or more moving masses impact a member to drive the member into another member, such as a pile into the soil. In another embodiment, each of the one or more moving masses is coupled to a voice coil actuator, and the machine is an electrical-mechanical-electrical transformer.

In certain embodiments, kinetic energy stored in the machine by the one or more moving masses is directly balanced by potential energy stored within the one or more pluralities of springs.

In certain embodiments, forces from the moving masses are transmitted to the non-moving mass, and the transmitted forces within the non-moving mass internally sum to zero or near zero, resulting in a net resulting force amplitude onto the non-moving mass at zero or near zero.

In certain embodiments, kinetic energy stored in the machine by the one or more moving masses is directly balanced by potential energy stored within the one or more pluralities of springs.

In certain embodiments, forces from the moving masses are transmitted to the non-moving mass, and the transmitted forces within the non-moving mass internally sum to zero or near zero, resulting in a net resulting force amplitude onto the non-moving mass at zero or near zero.

In certain embodiments, the machine operates on a system mode shape using lumped masses.

In certain embodiments, the machine has a resonance frequency, and when the machine is in resonance, the input oscillatory force is in phase with the oscillatory velocity of the one or two masses when the input oscillatory force is driven at the resonance frequency.

In certain embodiments, the coil assembly of each of the one or more voice coil actuators has little to no motion compared to the one or more moving masses.

### Vibrators

In certain embodiments, the resonance-enabled machine is configured to impart forces onto a structure. These devices are typically called vibrators. The vibrator comprises a housing, voice coil assembly, and a moving mass. The coil assembly is mounted to the housing, while the magnet assembly is mounted to the moving mass. The housing is coupled to the moving mass by springs. The coil assembly can be a coil of wires bound together to minimize the windings' thickness going through the magnetic field gap. This configuration reduces the magnetic field gap, enabling the coil to move through a higher magnetic field. Depending on the strength and internal eddy current losses, the coil wires may also be wrapped around a non-electrically conductive bobbin or an electrically conductive bobbin.

Without wishing to be bound by theory, as the mass oscillates, the moving mass deflection transmits a force onto the housing through the springs by F=k*x, where k is the spring rate (pound force per inch (lbf/in) or Newtons per meter (N/m)), x is the deflection (inches, meters), and F is the force transmitted (pounds force or Newtons). Instead of using a spinning eccentric as the force generated for the vibrator, the force transmitted through the springs is used to drive the system. In certain embodiments, the housing is rigidly mounted to a device vibrated with the forces coupled through the compliant members between the housing and the moving mass. The moving mass moves independently from the housing.

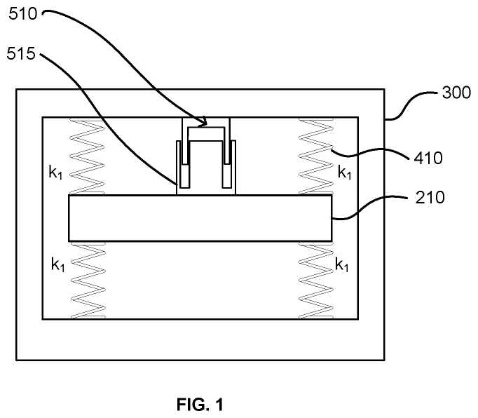

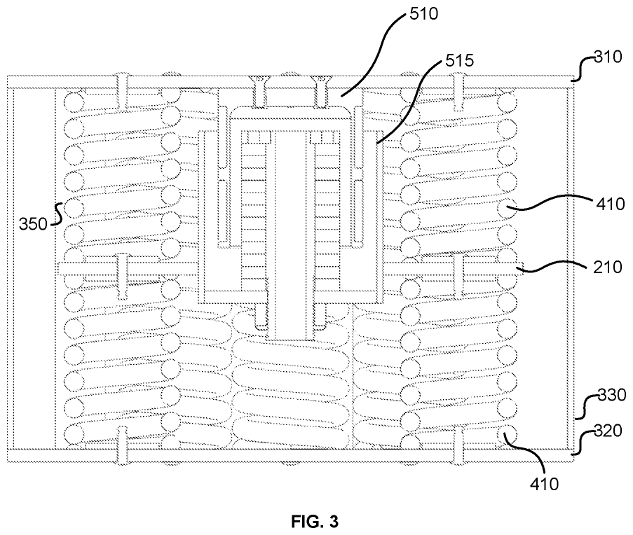

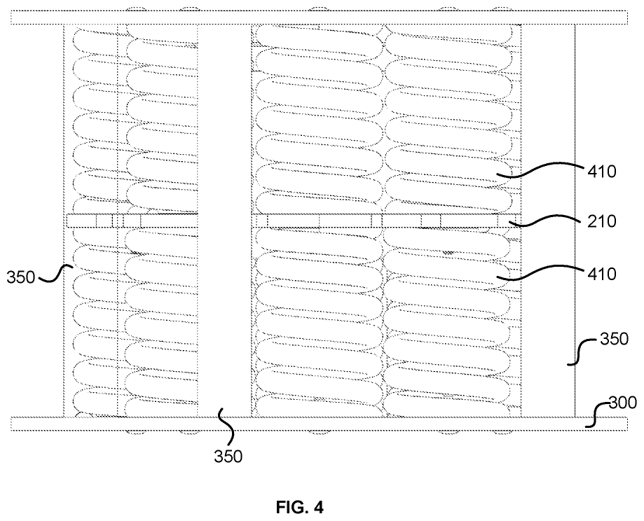

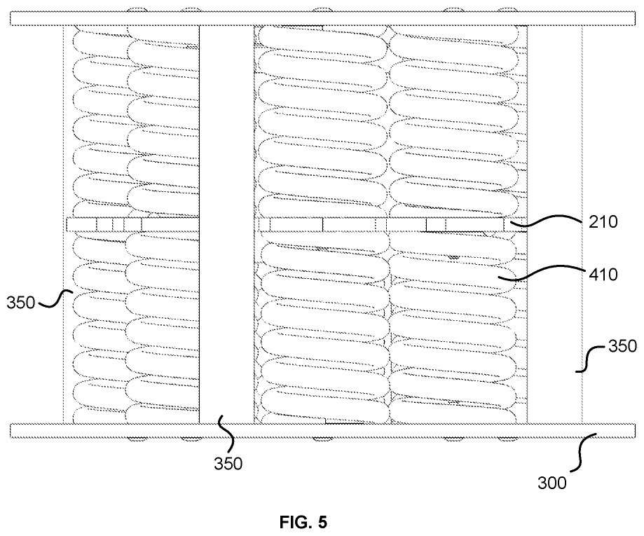

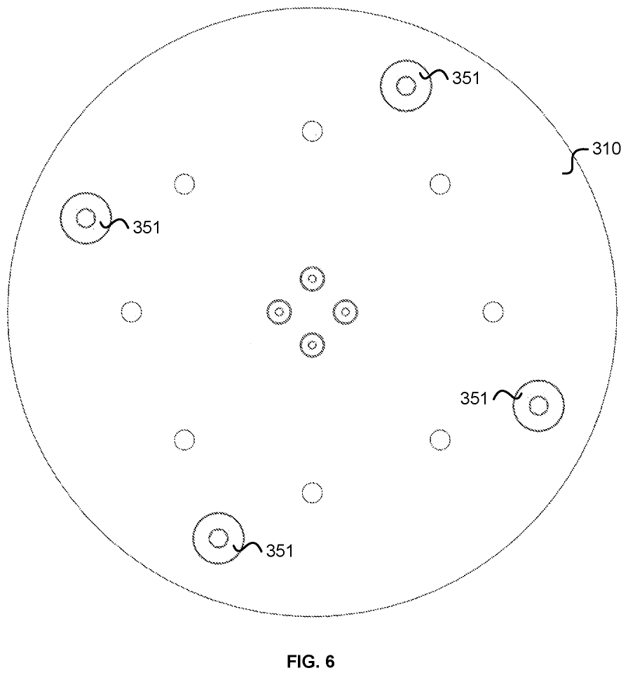

Resonance-enabled machines, such as vibrators, may comprise an actuator in the form of a voice coil to drive/operate the machine. For example, as depicted in FIGS. 1-8, the voice coil actuator 500 comprises a coil assembly 510, and a magnet assembly 515. In this embodiment of the single moving mass resonance-enabled machine, the voice coil magnet assembly 515 is disposed beneath and coupled to the moving mass 210.

FIG. 1 shows a resonance-enabled machine configured as a vibrator, comprising a housing 300, a moving mass 210 coupled to the housing 300 by a first plurality of resilient members 410, a coil assembly 510 disposed on and coupled to the housing 300, and a voice coil magnet assembly 515 coupled to the moving mass 210.

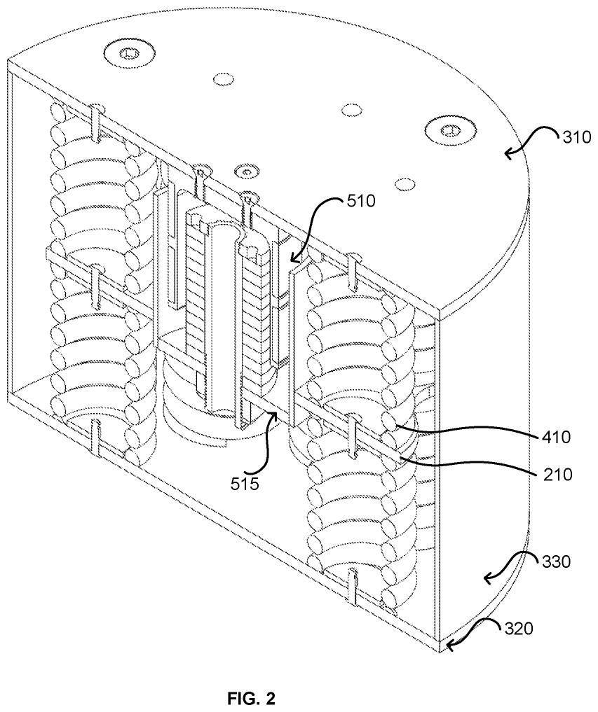

Referring to FIGS. 2-5, the moving mass 200 comprises a mass plate 221 disposed between a first housing plate 310 and a second housing plate 320. The moving mass plate 221 is coupled to the first housing plate 310 by a plurality housing-to-mass springs 410. The moving mass plate 221 is coupled to the second housing plate 320 by a plurality of mass-to-housing springs 420.

The electrical conductor is coupled to a bobbin 590. The magnet 510 is coupled to magnet housing 520. At least a portion of the bobbin 590 and at least a portion of the electrical conductor are configured to be positioned within a gap formed by the magnet 510 and the housing 520. The magnet 510 is configured to oscillate when an alternating current is applied to the electrical conductor. The moving mass 210 is coupled to the magnet housing 550.

Alternatively, the housing 300 is coupled to the bobbin 590. Each standoff 350 is joined to the first plate 310 with fastener 351 and the second plate 320.

Standoffs provide strength and rigidity to the machine. Separate resonant modes do not occur within the machine's structure. For instance, each mass 200 is assumed to be a rigid body, and the standoffs 350 ensure that each mass acts as a rigid body during machine operation. The number of standoffs in the plurality can be selected to accommodate the size of the machine, such as between 1 and 100, for example, 1, 2, 3, 4, 5, 6, 7, 8, 9, 10, 15, 20, 25, 30, 35, 40, 45, 50, 75, or 100. A large machine typically contains more standoffs than a smaller machine for strength and rigidity. Each standoff 350 is matched with springs 410 and fasteners 351, so as the number of standoffs 350 increases, so do the number of springs 410 and fasteners 351.

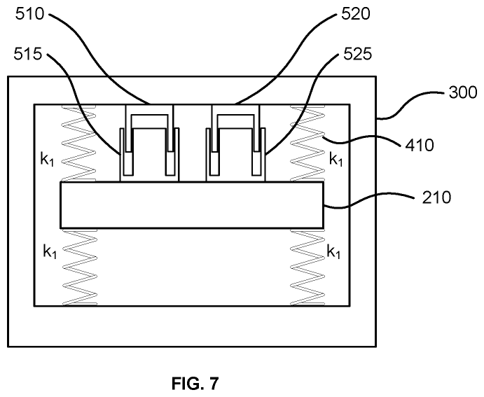

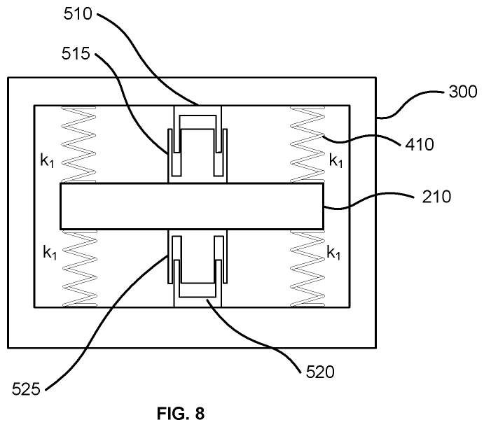

FIGS. 7 and 8 show a resonance-enabled machine configured as a vibrator, where the voice coil actuator 500 is the first voice coil actuator. The machine further comprises a second voice coil actuator coupled to the first moving mass 210. In some embodiments, the second voice coil actuator is configured to drive the moving mass 200 in phase with the first voice coil actuator. Additional voice coil actuators 500 can be added to provide power to the machine. These machines allow small and more cost-effective voice coils instead of a single, more expensive voice coil actuator.

### Vacuum Pump/Compressor

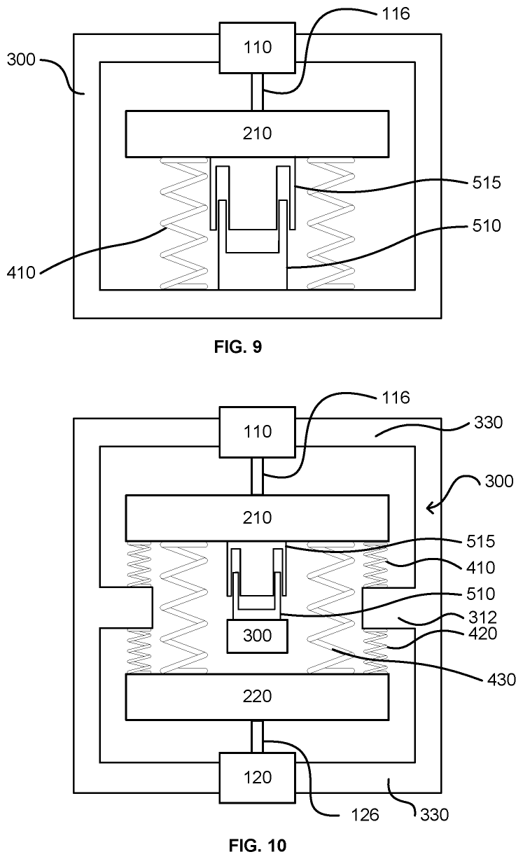

The present disclosure further provides a resonance-enabled machine configured as a vacuum pump or a compressor. Referring to FIG. 9, this embodiment is a resonance-enabled machine, where the single moving mass (oscillating mass) machine is coupled to a pump 110 mounted to a housing 300 through a barrel 116. The barrel 116 is rigidly attached to the moving mass 210 and drives the pump 110 mounted to the housing 300. The magnet assembly 515 is rigidly coupled to the moving mass 210. The coil assembly 510 is rigidly mounted to the housing 300, with little to no movement than the moving mass 210.

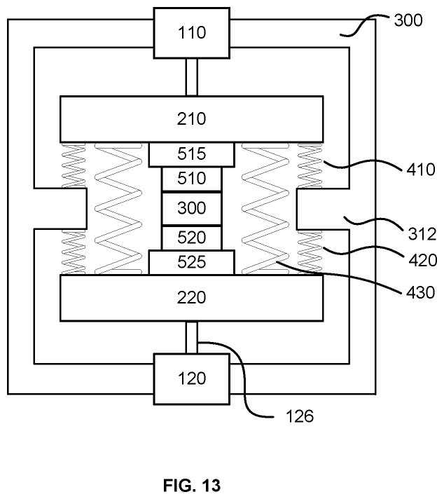

Referring now to FIGS. 9-13, a resonance-enabled vacuum pump/compressor comprises one or more voice coil actuators, one or more moving masses, and one or more pumps. In certain embodiments, the machine comprises a housing 300, which comprises a plurality of plates 310, 320, and 330. In addition, two moving masses 200, comprising two mass assemblies, first moving mass assembly 210 and second moving mass assembly 220, and are operatively coupled to the housing 300 by a first plurality of resilient members 400.

FIG. 10 shows a resonance-enabled machine comprising a housing 300, a first moving mass 210, and a second moving mass 220. The first moving mass 210 is rigidly coupled to the first magnet assembly 515, two pumps 110,120, a pair of housing-to-first moving mass springs 410, a pair of housing to second moving mass springs 420, a pair of first moving mass to second moving mass springs 430. The pump 110 is disposed on a first housing plate 310 and is coupled to the first moving mass 210 by a barrel 116. The first moving mass 210 is further coupled to a housing ledge 312 by a pair of housing-to-first moving mass springs 410 and a second moving mass 220 by a pair of first moving mass to second moving mass springs 430. The second moving mass is coupled to the housing via a pair of housing-to-second moving mass springs 420, the first mass 210 by a pair of first moving mass to second moving mass springs 430, and the second pump 120 by a second barrel 126. The second pump is disposed on a second housing plate 330 opposite the first pump 110. In certain embodiments, the first coil assembly 510 is rigidly coupled to the housing 300 and has little to no motion compared to the moving masses 210, 220.

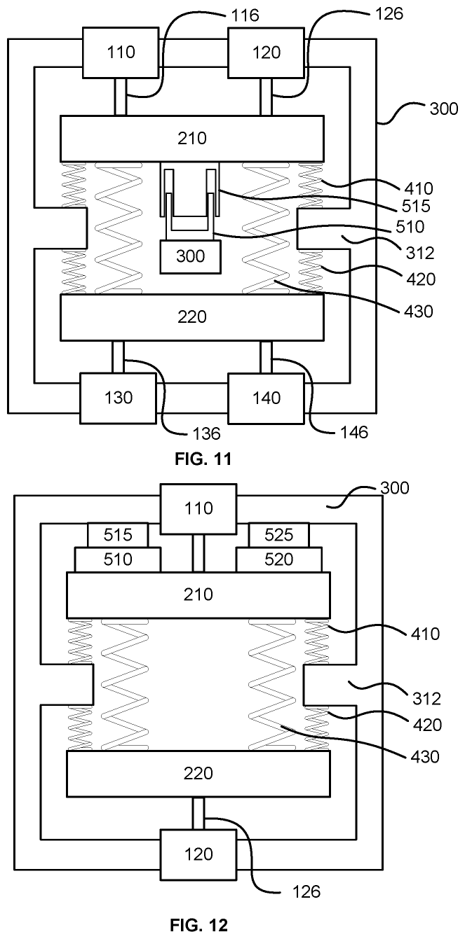

FIG. 11 shows a resonance-enabled vacuum pump/compressor, similar to FIG. 10, but comprising four pump heads 110, 120, 130, and 140 that can be plumbed in parallel (high flow) or series (higher pressure or vacuum) using tubing/hose. The machine is configured where the voice coil actuator 500 is the first voice coil actuator. The machine further comprises a second voice coil actuator coupled to the first moving mass 210. In some embodiments, the second voice coil actuator is configured to drive the moving mass 200 in phase with the first voice coil actuator. Additional voice coil actuators 500 can be added to provide power to the machine.

FIG. 12 shows a resonance-enabled vacuum pump/compressor, the vacuum or compressor machine with another multiple voice coil actuator configuration. Each moving mass 210, 220 is coupled to voice coil magnet assemblies 515, 525. It further comprises the first and second coil assemblies 510, 520 coupled to the housing 300.

### Jackhammer or Demolition Hammer

A jackhammer is typically driven by a pneumatic, electromechanical, internal combustion engine, and hydraulic machine. It typically uses bits or chisels to drive and break a substrate. The electromagnetic hammers use an electric motor to rotate a crank, which drives a piston that interacts with a free-flight piston through an air spring. The free-floating mass is directly connected to the chisel, impacting the substrate to cause failure and demolition.

The present disclosure provides a resonance-enabled machine driven by an electromechanical voice coil and two oscillating masses (moving masses). The oscillating masses are coupled through mechanical springs. The masses are configured to oscillate out of phase (180 degrees) and coupled to the housing with resilient members, such as one or more pluralities of springs, to obtain near-zero oscillating result force onto the housing. Thus, a user feels negligible forces because the resulting oscillating forces onto the housing are significantly reduced. Using prior devices, Raynaud syndrome or carpal tunnel syndrome frequently results from prolonged usage under loads back onto the user.

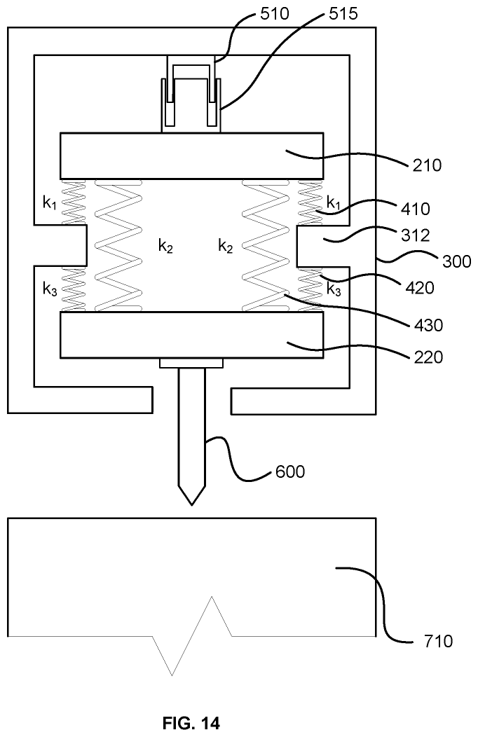

FIG. 14 shows a resonance-enabled machine configured as a jackhammer or demolition hammer. The machine comprises a hammer chisel 600 rigidly coupled to the second moving mass 220. As the hammer chisel 600 oscillates, it contacts medium 710 (such as concrete, asphalt, wood, ice, rock, soil, etc.) and impacts the medium 710, causing it to fail. Other configurations and adaptations include, for example, mounting the hammer chisel 600 to the first moving mass 210.

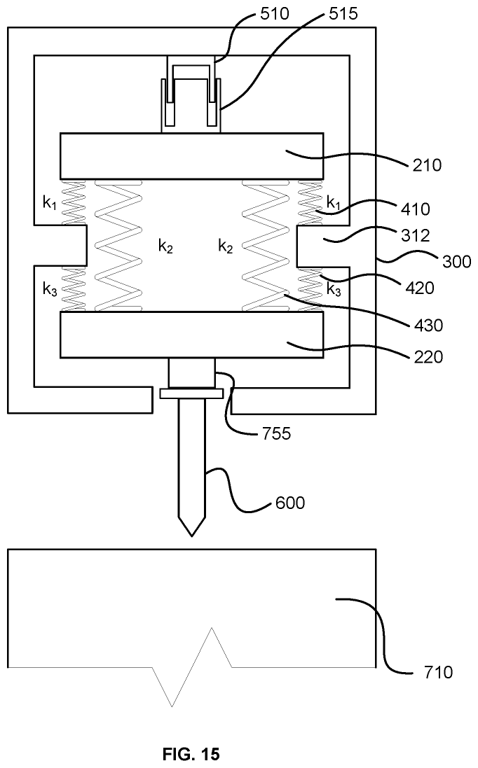

FIG. 15 shows a resonance-enabled machine configured as a hammer/chisel that operates at zero or near-zero alternating force transmitted to frame 300 during operation. A spring-damper 755 is disposed between the second moving mass 220 and the hammer/chisel 600 to tune the hammer/chisel impact forces. By operating the device with a measured ±60 g (±588 m/s²) of oscillation acceleration at the second moving mass 220, drawing an average of 120 W, the system hammer/chiseled a 1″ diameter (2.54 cm) hole in a 3″ thick (7.62 cm) piece of sandstone.

### Pile Driver/Post Pounder/Hammer

A pile driver drives piles into soil. The piles support the foundations of buildings or other structures. Smaller devices drive posts for fencing. Impact devices, such as this type of device, are also referred to as hammers. With prior devices, the resulting forces are directly transferred to the user or the rig holding the hammer, fatiguing and damaging mechanical components, and vibrating the rig user.

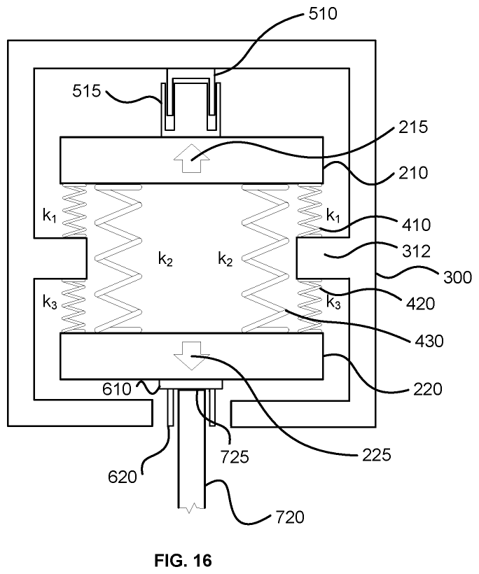

FIG. 16 shows a resonance-enabled machine configured as a pile driver, post pounder, or hammer. The machine comprises an anvil 610 coupled to the second moving mass 220 that oscillates or near the down position, the anvil 610 impacts the pile 720 at the impact zone 725. When the anvil 610 impacts the pile 720, the motion of the first moving mass 215 is at or near the topmost position, and the motion of the second moving mass 225 is at or near the lowest moving position. Thus, the first moving mass 210 oscillates at or near 180° out of phase compared to the second moving mass 220. The housing 300 can be mounted to a mechanical device called a rig to perform the pounding, or it can further comprise handles for a user to hold while pounding a workpiece. The adapter sleeve 620 guides the pile/post to hit the anvil 610.

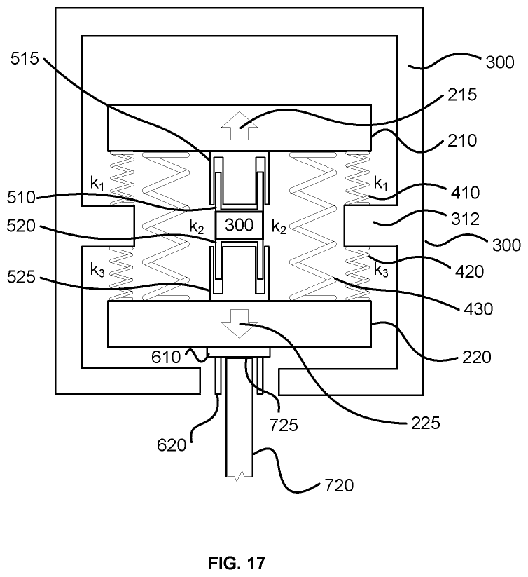

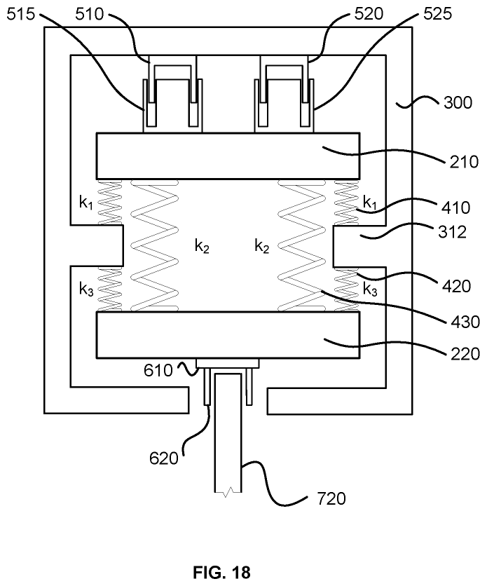

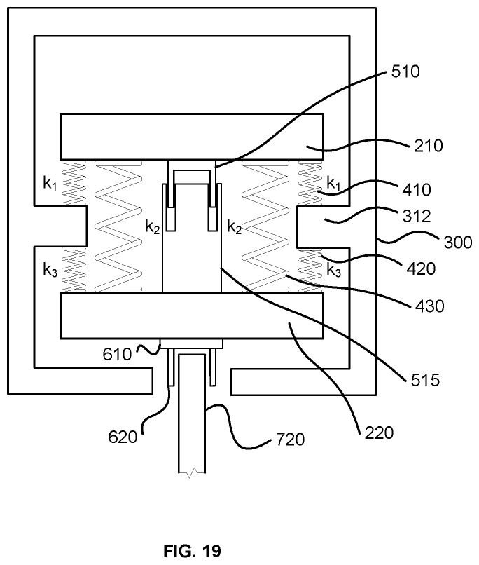

FIG. 17 shows a resonance-enabled machine configured as a pile driver, post pounder, or hammer. The machine comprises multiple voice coil actuators. The first moving mass 210 is coupled to the first magnet assembly 515 and coupled to the housing ledge 312 by a pair of housing-to-first moving mass springs 410 and to the second mass 220 by a pair of first moving mass to second moving mass springs 430. The second mass 220 is coupled to the housing 300 via a pair of housing-to-second moving mass springs 420, the first mass 210 by a pair of first moving mass to second moving mass springs 430, and a second magnet assembly 525, and an anvil 610. In certain embodiments, the first coil assembly 510 and second coil assembly 520 are rigidly coupled to the housing 300 and have little to no motion compared to the first and second moving masses 210,220.

FIG. 18 shows a resonance-enabled machine configured as a pile driver, post pounder, or hammer. The machine comprises multiple voice coil actuators. The first moving mass 210 is coupled to the first and second magnet assemblies 515, 525, and coupled to the housing ledge 312 by a pair of housing-to-first moving mass springs 410 and the second mass 220 by a pair of first moving mass to second moving mass springs 430. The second mass is coupled to the housing via a pair of housing-to-second moving mass springs 420, the first mass 210 by a pair of first moving mass to second moving mass springs 430 and anvil 610. In certain embodiments, the first coil assembly 510 and second coil assembly 520 are rigidly coupled to the housing 300 and have little to no motion compared to the first and second moving masses 210,220.

FIG. 18 shows a resonance-enabled machine configured as a pile driver, post pounder, or hammer. The first moving mass 210 is coupled to a first coil assembly 510 and coupled to the housing ledge 312 by a pair of housing-to-first moving mass springs 410 and the second mass 220 by a pair of first moving mass to second moving mass springs 430. The second mass is coupled to the housing via a pair of housing-to-second moving mass springs 420, to the first mass 210 by a pair of first moving mass to second moving mass springs 430, the first magnet assembly 515, and to an anvil 610.

Both the first coil assembly 510 and the first magnet assembly 515 are oscillating/moving, providing the greatest efficiency because each side of the voice coil assembly 500 has equal and opposite forces. Without wishing to be bound by theory, this balance of forces translates into power by P=Fv, where P is the power in Watts, F is the force in Newtons, and v is the velocity in meters second⁻¹. Thus, the mounting order for the first coil assembly 510 and the first magnet assembly 515 to the moving masses 200 can be either orientation.

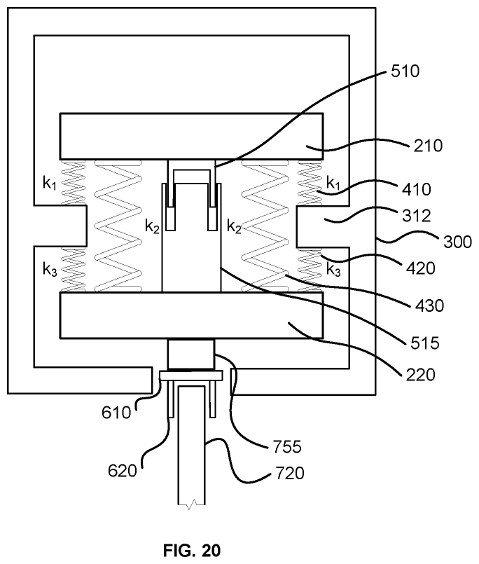

FIG. 20 shows a resonance-enabled machine configured as a pile driver, post pounder, or hammer, comprising one voice coil actuator 500 between two moving masses 210, 220. A spring-damper 755 is disposed between the second moving mass 220 and the anvil 610. The system drove a 2⅞″ (7.3 cm) drill pipe 12″ (0.30 m) into decomposed granite in 10 minutes. The power was less than 125 W while operating at about 72 Hz. The spring-damper 550 was made of rubber with a spring rate of about 800 lbf/in (90.4 N/m).

### Soil Compactor

Soil compactors are notoriously inefficient, loud, and transmit vibrations to the user. Prior systems typically use spinning eccentric masses to generate forces onto a plate that vibrates on the ground. These prior systems are limited because of the mass to low vibration accelerations to have effective compaction. Higher mass typically results in better and more efficient compaction. With larger masses, higher forces keep the same vibration amplitude (F=m*a), where F is the force, m is the mass, and a is the vibration acceleration amplitude.

The resonance-enabled machines disclosed herein have solved these problems by providing a more efficient method to perform soil compaction, thus saving money and reducing power loads. In addition, the disclosed resonance-enabled soil compactor permits mass additions without sacrificing performance, cancels the forces to the housing and ultimately to the user, and is efficient enough to run on handheld batteries less than or equal to 9 A-hr.

Two moving masses move out of phase of one another. Spring rates are sized to reduce the net force to near-zero transmitted to the housing and ultimately to the user. In certain embodiments, the machine comprises an additional housing mass to further decrease the vibrations to the user. Additional embodiments include methods for adding mass to the housing to change the compaction rate and compaction depth.

The present disclosure provides a resonance-enabled soil compactor comprising a housing, a plurality of moving masses/plates, and a plurality of standoffs. The voice coil is coupled to the housing mass, and the voice coil magnet assembly is mounted to one of the primary moving masses. One or two masses are coupled to the housing by the first plurality of resilient members—a second plurality of resilient members couple the masses. When present, the two moving masses are 180° out of phase of one another on or near mechanical resonance. The resultant forces transmitted through the springs to housing are at or near zero.

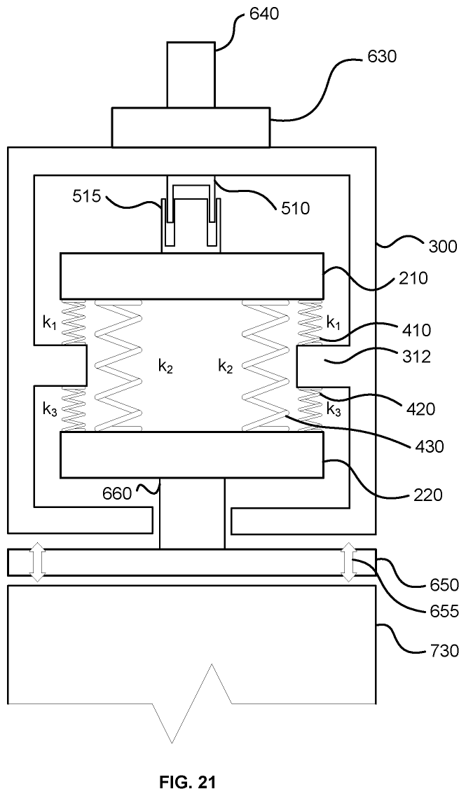

FIG. 21 shows a resonance-enabled soil compactor with one voice coil actuator and two moving masses. The first moving mass 210 is coupled to the first magnet assembly 515 and coupled to the housing ledge 312 by a pair of housing-to-first moving mass springs 410 and to the second mass 220 by a pair of first moving mass to second moving mass springs 430. The second mass is coupled to the housing via a pair of housing-to-second moving mass springs 420, the first mass 210 by a pair of first moving mass to second moving mass springs 430, and a coupler 660. The coupler 660 is coupled to the tamping plate 650 to the second moving mass 220. The first coil assembly 510 is rigidly coupled to the housing 300 and has little to no motion compared the first and second moving masses 210,220. The tamping plate 650 oscillates back and forth 655 and is depicted in the mid-stroke location.

The tamping plate 650 impacts the soil 730 at or near the bottom of the oscillation. At the configuration shown at the midrange of the tamping plate oscillation 655, the machine appears to be levitating. In certain embodiments, the housing 300 permits a user to mount weights 630 and lock the weights 630 in place using weights clamp 640. In addition, a user can hold the housing 300 or a handle rigidly connected or coupled using springs or dampers to the housing 300.

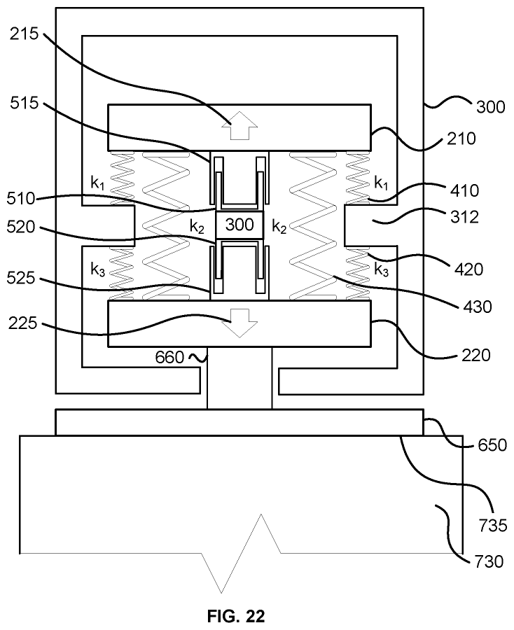

FIG. 22 shows a resonance-enabled soil compactor comprising two voice coil actuators between two masses. The first moving mass 210 is coupled to the first magnet assembly 515 and coupled to the housing ledge 312 by a pair of housing-to-first moving mass springs 410 and to the second mass 220 by a pair of first moving mass to second moving mass springs 430. The second mass 220 is coupled to the housing 300 via a pair of housing-to-second moving mass springs 420, the first mass 210 by a pair of first moving mass to second moving mass springs 430, a second magnet assembly 525, and to a coupler 660. The coupler 660 couples the tamping plate 650 to the second moving mass 220. In certain embodiments, the first coil assembly 510 and second coil assembly 520 are rigidly coupled to the housing 300 and have little to no motion compared to the first and second moving masses 210,220.

The tamping plate 650 oscillates back and forth 655 and is depicted at or near the oscillation stroke's bottom. As depicted, the tamping plate 650 impacts the soil 730 over the impact area 735 at or near the oscillation stroke's bottom. When the motion of the first moving mass 215 is at or near the top of the oscillation, the second moving mass 225 is at or near the bottom of the oscillation motion, as depicted. Thus, the first moving mass 210 and the second moving mass 220 oscillate at or near 180° out of phase.

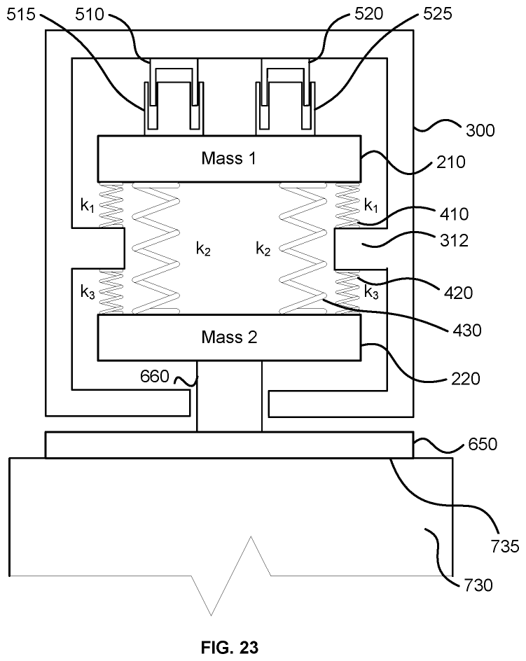

FIG. 23 shows a resonance-enabled soil compactor comprising multiple voice coil actuators on opposite sides of two moving masses. The first moving mass 210 is coupled to the first and second magnet assemblies 515, 525, and coupled to the housing ledge 312 by a pair of housing-to-first moving mass springs 410, and to the second mass 220 by a pair of first moving mass to second moving mass springs 430. The second mass is coupled to the housing via a pair of housing-to-second moving mass springs 420, the first mass 210 by a pair of first moving mass to second moving mass springs 430, and a coupler 660. In certain embodiments, the first coil assembly 510 and second coil assembly 520 are rigidly coupled to the housing 300 and have little to no motion compared to the first and second moving masses 210,220.

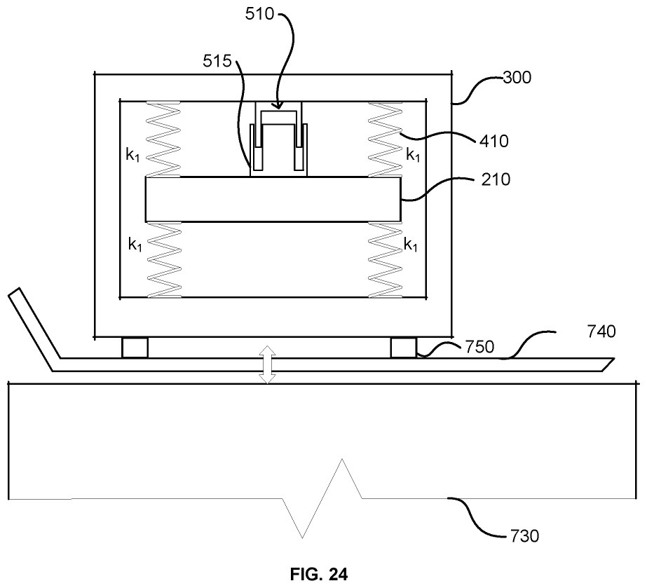

FIG. 24 shows a resonance-enabled machine configured as a soil compactor, comprising a housing 300, a moving mass 210 coupled to the housing 300 by the first plurality of resilient members 410, a coil assembly 510 disposed on and coupled to the housing 300, and a voice coil magnet assembly 515 coupled to the moving mass 210. The force generator can be hard mounted, for example, via one or more dampers 750 to a baseplate 740 to compact the soil 730. The system can be battery-powered at less than 160 W under normal operating conditions with an 18″×12″ (0.46 m×0.30 m) plate operating around 50 Hz, generating an alternating force of ±1000 lbf (4448 N) and moving the baseplate 740 with an alternating acceleration of 20 g (±196 m/s²).

An additional configuration was operated with springs 410 k₁ at 13,500 lbf/in (2,364,000 N/m). The system was operated at frequencies from 90-95 Hz. The system on loosely compacted soil used 280 W and operated with an oscillation acceleration of 12.5 g (±122.6 m/s²) of acceleration. As the soil compacted, the acceleration dropped to +5 g (±49.0 m/s²) of acceleration. On the onset of compaction, the acceleration was measured over ±20 g (±196 m/s²) on the first moving mass 210. When the system was put on soft foam with a spring rate less than 800 lbf/in (90.4 N/m), the system measured above ±60 g (±588 m/s²) of acceleration on the first moving mass 210 and required less than 60 W. At ±60 g (±588 m/s²) of acceleration, and the system generated over ±900 lbf (4003 N) to drive the soil compaction.

In certain embodiments, the resonance-enabled machine can determine soil compaction by the measured decrease in operational acceleration of the first moving mass 210.

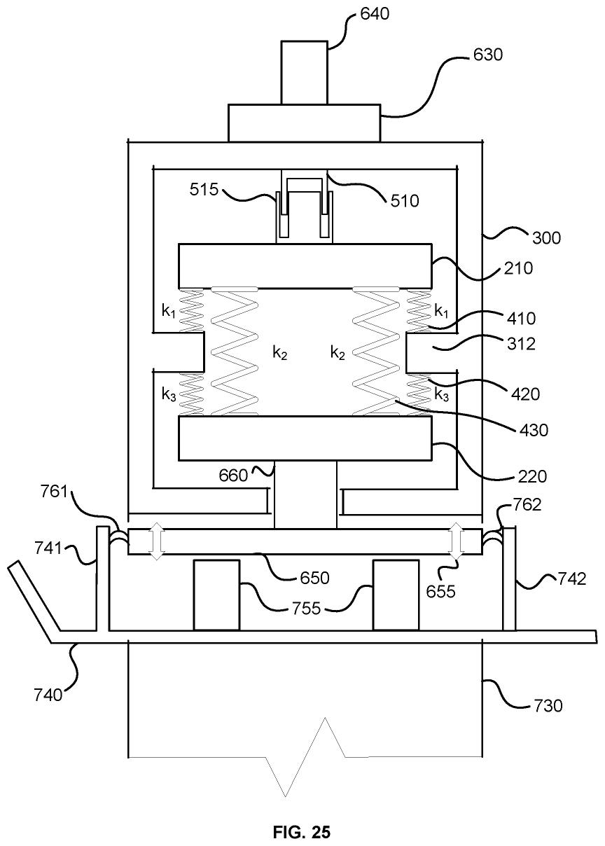

FIG. 25 shows a resonance-enabled machine configured as a tamper with zero or near-zero alternating force transmitted to the frame 300 during operation. The tamper comprises one voice coil actuator 500 and two moving masses 210,220. The first moving mass 210 is coupled to the first magnet assembly 515 and coupled to the housing ledge 312 by a pair of housing-to-first moving mass springs 410 and to the second mass 220 by a pair of first moving mass to second moving mass springs 430. The second mass is coupled to the housing via a pair of housing-to-second moving mass springs 420, the first mass 210 by a pair of first moving mass to second moving mass springs 430, and a coupler 660. The coupler 660 is coupled to the tamping plate 650 to the second moving mass 220. The first coil assembly 510 is rigidly coupled to the housing 300 and has little to no oscillation motion compared to the first and second moving masses 210,220. The tamping plate 650 oscillates back and forth 655 and is depicted in the mid-stroke location. In certain embodiments, the spring-damper 755 is rigidly attached to the tamping plate 650 so that they are always in contact.

The baseplate 740 comprises a first wall 741 and a second wall 742. Two spring-dampers 755 are disposed between the tamping plate 650 and the baseplate 740. In certain embodiments, the spring-dampers 755 stay in contact with tamping plate 650. In certain embodiments, the spring-dampers 755 are separated during the oscillation of the tamping plate 650 and then come back into contact.

A first guide 761 is disposed between the first wall 741, and the proximal end of the tamping plate 650. A second guide 762 is disposed between second wall 742, and the distal end of the tamping plate 650. The guides 760 keep the tamping plate 650 and the baseplate 740 aligned. In certain embodiments, when the baseplate 740 has a circular configuration, the guide is single guide circumferentially disposed on the baseplate rather than multiple guides disposed in a series.

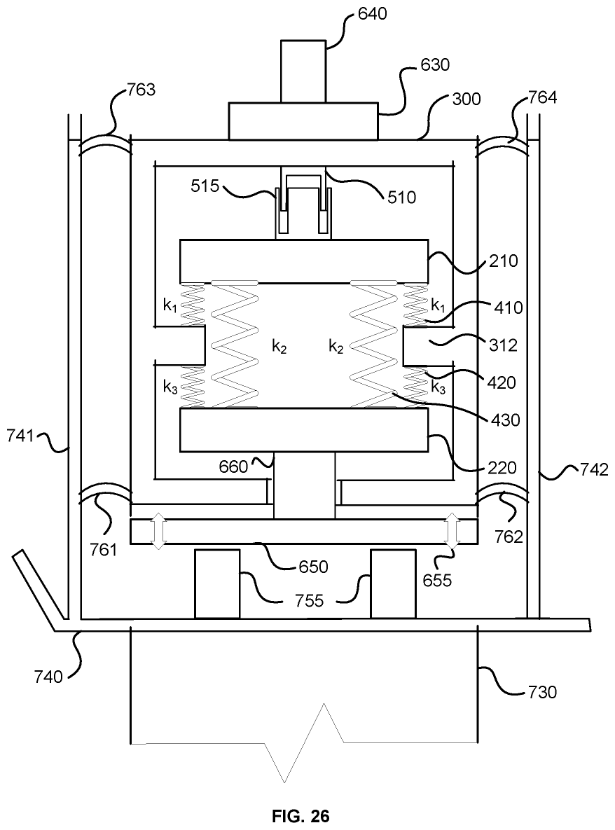

FIG. 26 shows another resonance-enabled machine configured as a tamper similar to FIG. 25. Here, the first and second walls 741,742 are taller than the previous embodiment, reaching roughly the same height as the frame 300. Two spring-dampers 755 are disposed between the tamping plate 650 and the baseplate 740. A first guide 761 is disposed between the first wall 741 and the proximal end of the bottom of frame 300. A second guide 762 is disposed between second wall 742 and the distal end of the bottom of frame 300. A third guide 763 is disposed between the first wall 741 and the proximal end of the top of frame 300. A fourth guide 764 is disposed between second wall 742 and the distal end of the top of frame 300.

The spring-dampers 755 tune the compaction forces. In certain embodiments, when the spring-dampers 755 are rigidly connected to the tamping plate 650, guides 761, 762, 763, and 764 are optional.

At a frequency of about 73 Hz, the system used <125 W to drive the tamping plate 650 to an oscillation accelerations of ±60 g (±588 m/s²) with a spring-damper 755 of natural rubber with a measured spring rate of 800 lbf/in (140,101 N/m). If weights 630 are added with 200 lbs. (90.7 kg), then the system used <170 W to drive the tamping plate 650 with measured oscillation accelerations of ±60 g (±588 m/s²) with a spring-damper 755 of natural rubber with a measured spring rate of 800 lbf/in (140,101 N/m).

The disclosed resonance-enabled machine enables minimal energy to perform the soil compaction. Only additional energy travels through the machine and compacts the soil. Prior systems use most of their energy just to move or oscillate the plates back and forth. Only the leftover energy compacts the soil. This configuration enables modest-sized power sources of less than two 9 A-hr batteries for a 7.5 hr run time at 120 W with typical soil.

With battery power, minimal noise is generated. As a result, the machine can be used after dark or under strict noise ordinances. The smaller-sized batteries enable the machine to use the same batteries as portable power tools operating at 12-50 Volts per battery.

In certain embodiments, the machine generates less heat than prior systems. For example, less heat becomes important in small or confined spaces, such as a basement.

In certain embodiments, the resonance-enabled machine is configured to have two primary masses move back and forth with a housing mass coupled to a handle. In addition, mass can be added to the housing mass, which increases the machine's static load onto the soil to be compacted, which increases the coupling/energy transfer between the moving mass and the soil.

In certain embodiments, the energy input directly transfers to the soil. As a result, the machine consumes little to no additional energy as intrinsic losses. Therefore, by adding static mass to the machine, the machine performance increases. In prior systems, performance decreased instead because the additional mass absorbed more energy. Less energy was transferred to the soil, resulting in less efficient compaction. The adjustment of static mass allows the disclosed machine to be configured to each soil condition.

Disclosed resonance-enabled machines are configured at various frequency ranges, providing different penetration depths of the soil. As a result, the machine's performance does not depend on frequency. In contrast, prior eccentric-driven machines generate higher forces and become more efficient at higher frequencies.

The present disclosure provides a resonance-enabled machine, wherein the amount of coupling/energy absorption of the soil is measured by how the machine reacts while operating at or near resonance. The soil compaction properties are provided to the user and show when the soil has been compacted. In this machine, the resonance of the machine can be dynamically modulated to accommodate the soil type and condition, which can change throughout compaction.

### Single-Phase Transformer

US electrical grids comprise millions of step-down transformers to deliver electricity to end-users in industry, commerce, and residences. Installed on poles and pads, these ubiquitous devices traditionally use induction to reduce output voltages to safe service levels for metered customers. Modern transformers have changed very little over the past 70 years. Their efficiency, simplicity, and reliability have been widely accepted.

The incumbent design has flaws. Efficiency falls off considerably at moderate to light loads. It offers essentially no protection against surges and electromagnetic pulses, a vulnerability for terrorist attacks. Electromagnetic pulses have also concerned the Working Group for the United Nations Committee on the Peaceful Uses of Outer Space (COPUOS). Solar mass ejections (SME) can cause extensive worldwide damage to national electrical grids and electronically based systems. Governments have been encouraged to take action to shield grids and electronic devices from a major SME event. The resonance-enabled transformers disclosed herein are less vulnerable to SME events than prior systems.

The present disclosure provides an electrical-mechanical-electrical transformer that is lighter and more compact than prior systems. It reduces resistive heat loss and conserves galvanic and ground fault isolation. It also acts as a bandpass filter. Only allowing coupling through the machine at the designed frequency protects against electrical interference and noise between machines. The electrical-mechanical-electrical coupling uses the windings' velocity through a static magnetic field to reduce the number of windings compared to prior transformers. A higher voltage will be generated in the static magnetic field generated by the permanent magnets with higher velocity.

The disclosed resonance-enabled transformer uses an oscillating mechanical system to magnify the electromagnetic induction between the input and output. Typically, such a system would have potential energy losses (from compressing springs) and kinetic energy losses (from changing velocities of the moving mass). These losses have historically made mechanical designs inferior to inductive designs. On mechanical resonance, the potential and kinetic energy of the system are matched. They are internally exchanged during each oscillation, allowing energy to be transferred through the mechanical system with negligible losses.

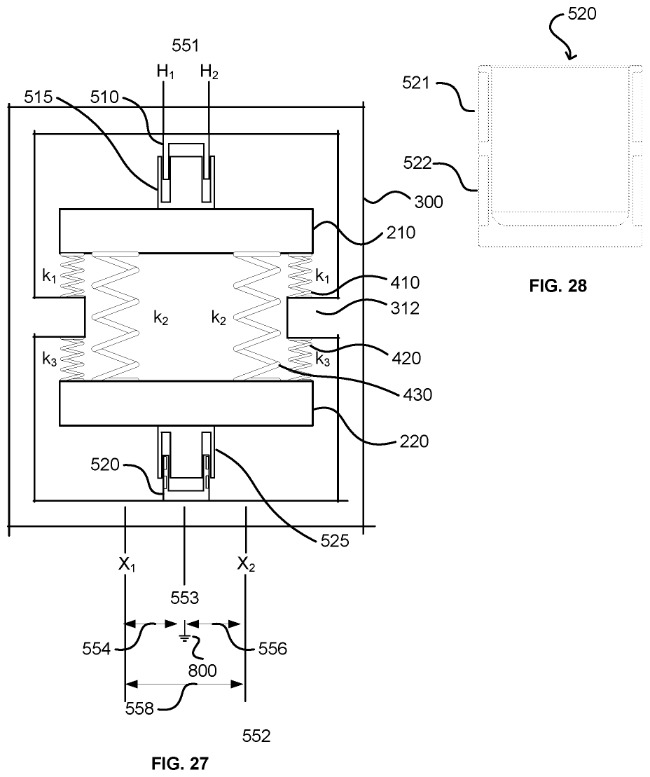

Referring to FIG. 27, the resonance-enabled single-phase transformer comprises a fixed voice coil bobbin 510 at the supply side/primary winding 551 (electrical line input) and a fixed coil bobbin 520 at the load side/secondary winding output 552. These bobbins 510,520 interact with oscillating magnet assemblies 515,525 attached to spring-mounted plates 210,220, referred to as masses 210,220.

The supply side/primary winding 551 has an input voltage 810 across leads H₁ and H₂. A load side/secondary winding 552 has an output voltage 820 across leads X₁, X₂, H₁, and H₂. The first moving mass 210 is coupled to the first magnet assembly 515 and the housing ledge 312 by a pair of housing-to-first moving mass springs 410. The first moving mass 210 is also coupled to the second moving mass 220 by a pair of first moving mass to second moving mass springs 430. The second moving mass is coupled to the housing via a pair of housing-to-second moving mass springs 420, the first mass 210 by a pair of first moving mass to second moving mass springs 430, and the second magnet assembly 525. In certain embodiments, the first coil assembly (fixed voice coil bobbin) 510 and second coil assembly (fixed coil bobbin) 520 are rigidly coupled to the housing 300 and have little to no motion compared to the first and second moving masses 210,220.

FIG. 28 shows the second coil assembly 520, which comprises two independently wrapped coils, first coil 521 and second coil 522. The start of the load side/secondary winding 552 wire leads X₁ and wraps the first coil 521, then a center tap/ground/neutral 553 is X₂. Then, the second coil 522 is wrapped counter-rotation than the first coil 521. The end of the wrapped coil is X₃. The secondary first line voltage 554 is measured between X₁ and X₂. The secondary second line voltage 556 is measured between X₂ and X₃. and the secondary third voltage 556 is measured between X₁ and X₃.

Generally, the voltage can and will vary, depending on the user's demands and the electric grid. For example, in standard residential housing in North America, the secondary first line voltage 552 and the secondary second line voltage 554 are 120 Volts AC. The secondary third voltage 558 is 240 Volts AC. The primary winding 551 voltage is most commonly 470 Volts AC in the United States. The user can tune the disclosed transformers to other voltages.

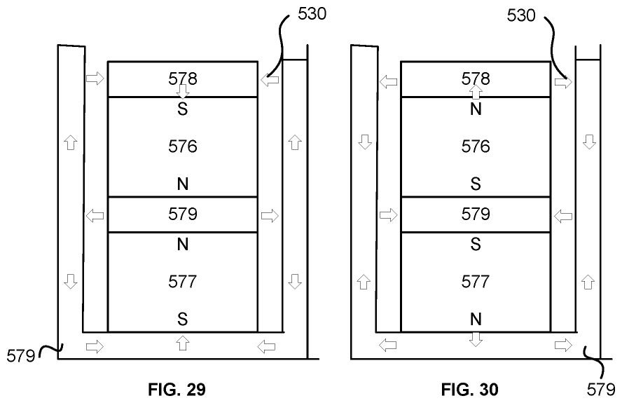

FIG. 29 shows the second magnet assembly 525 cross-section. The magnet assembly 525 comprises a first spacer 578 coupled to a first magnet 576 with north facing down coupled to a second spacer 579 coupled to a second magnet 577 with north facing up coupled to a magnet housing 530. In this embodiment, the machine has two magnetic field loops 531. The first magnetic field loop 531 travels from the second magnet 577 up to the second spacer 579 across a gap to the magnet housing 580 and then travels down the magnet housing 580 and back across a gap to the second magnet 577. The second magnet field loop travels from the first magnet 576 to the second spacer 579 across a gap to the magnet housing 580 up near the top of the magnetic housing 580 and back across a gap to the first spacer 578 and back to the first magnet 576.

FIG. 30 shows the second magnet assembly 525 cross-section in a further embodiment. The magnet assembly 525 comprises a first spacer 578 coupled to a first magnet 576 with north facing up coupled to a second spacer 579 coupled to a second magnet 577 with north-facing down coupled to a magnet housing 530. The machine shown has two magnetic field 531 loops. The first magnetic field loop travels from the second magnet 577 down to the magnet housing 580, partway up to about the same level as the second spacer 579, across a gap to the second spacer 579 then back to the second magnet 577. The second magnet field loop travels from the first magnet 576 to the first spacer 528 across a gap to the magnet housing 580 down near the second spacer 579 crosses a gap to the second spacer 579 then back to the first magnet 576.

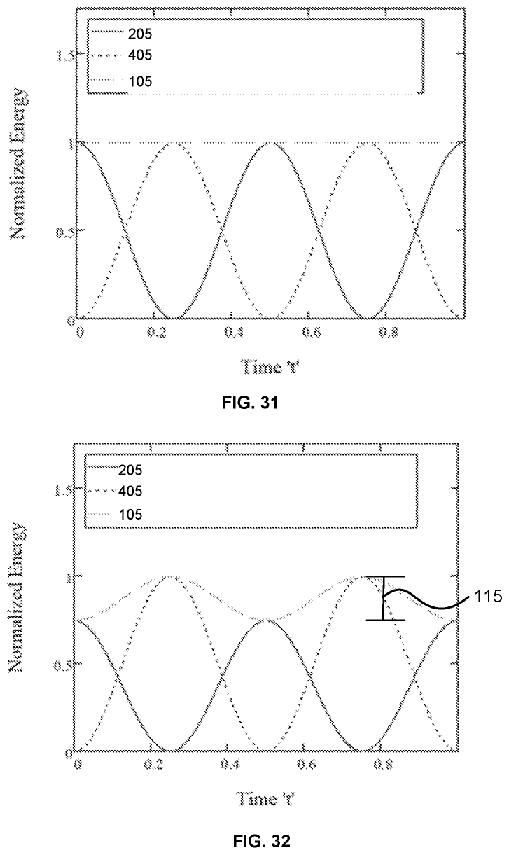

FIG. 31 shows the potential energy 405 and kinetic energy 205 changes as a function of time. The total energy in machine 105 is the summation of the kinetic energy 205 and potential energy 405 at any given time. When operating on mechanical resonance, machine 105 is constant, so no additional energy is needed. Because the energy is conserved within the machine, additional energy freely flows through the machine with negligible loss.

By incorporating a tuned design, all internal forces within the resonance-enabled machine during oscillation are contained while transmitting negligible vibrations through the housing 300 to the ground 800. By oscillating the two moving masses out of phase of one another and matching the forces transferred through the springs, vibrations are contained within the machine rather than transmitted through the housing 300 to the ground 800. Without wishing to be bound by theory, the masses move at a consistent oscillation amplitude relative to each other set by the mode shape, allowing the forces to cancel within the machine.

FIG. 32 shows the energy when the resonance-enabled transformer operates at a frequency below mechanical resonance. The potential energy 405 stored and released by the springs 410,420 is greater than the kinetic energy 205 stored and released by the mass when operated below mechanical resonance. Therefore, the energy 115 that can be stored as potential energy 405 and the kinetic energy 205 are the mechanical system's energy loss operating off mechanical resonance.

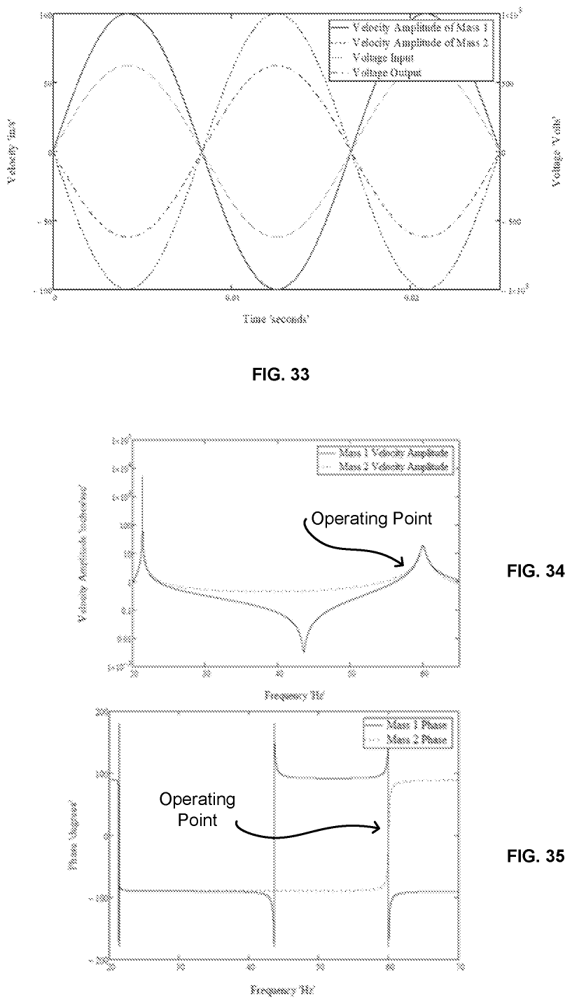

FIG. 33 shows a single-phase (one-to-one ratio) transformer that matches the input voltage 810 to the output voltage 820. The velocities of the first moving mass 210 and the second moving mass 220. In this embodiment, the first moving mass 210 and the second moving mass 220 velocities are 180° out of phase of one another.

FIGS. 34 and 35 show the bode plots, including the amplitude, magnitude, and phase of the first moving mass 210 and the second moving mass 220. The resonance-enabled machine's oscillating masses move per the resonant mode shape, tuned so that the first moving mass 210 and the second moving mass 220 are 180° out of phase of one another. The operating point is labeled on the plots at 60 Hz, the power grid's operating frequency in North America.

Generally, the frequency can and will vary. The user may select and tune the oscillation per the needs of the electric grid. For example, the operating frequency is between 48 Hz and 62 Hz, such as between 50 Hz and 60 Hz. In one embodiment, the masses oscillate at 60 Hz to match North American grid frequencies. In another embodiment, a 50 Hz operating frequency is used. The desired output voltage is achieved per Lenz's Law and Faraday's Law of Induction.

Without wishing to be bound by theory, the voltage governs the first moving mass vibrational amplitude. The force on force on the first moving mass 210 governs the transmitted energy, which the input current sets to the first coil assembly 510, per F=kBLIN and E=kBLvN, respectively, where F=Force, k=constant, B=Magnetic flux density, I=Current, L=Length of a conductor, N=Number of conductors, E=Voltage, and v=Velocity of the conductor. The power going into a coil is calculated by multiplying the current with the voltage. The power going into the first coil assembly 510 may be converted to heat from resistive heating, or heat from inductive heating, or mechanical power. In this circumstance, the power equation simplifies to P=EI=I2R+kBLvNI.

Suppose the current is divided by both sides of the equation. The voltage equals E=IR+kBLvN, where the IR becomes negligible, and the voltage becomes controlled by the coil design multiplied by the velocity. The machine operates on mechanical resonance and energy without a load. When the load is applied, it dampens the machine under a purely resistive load. The machine applies a higher current to match the load and keep the input velocity relatively unchanged. In certain embodiments, it has a minor voltage reduction due to resistive heating.

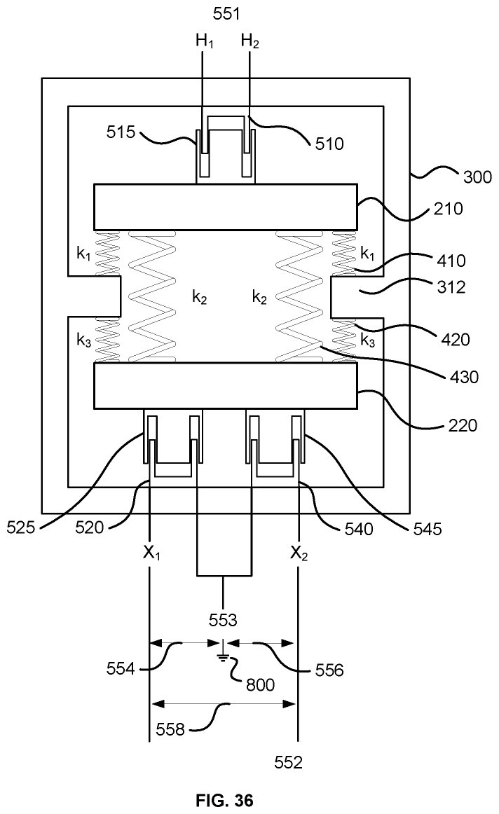

FIG. 36 shows an electrical-mechanical-electrical transformer comprising a supply side/primary winding 551, a load side/secondary winding 552, and three voice coil actuators. The first moving mass 210 is coupled to the first magnet assembly 515 and the housing ledge 312 by a pair of housing-to-first moving mass springs 410. The first moving mass 210 is also coupled to the second moving mass 220 by a pair of first moving mass to second moving mass springs 430. The second moving mass is coupled to the housing 300 via a pair of housing-to-second moving mass springs 420, the first mass 210 by a pair of first moving mass to second moving mass springs 430, and the second magnet assembly 525, and a third magnet assembly 545. The first coil assembly 510, second coil assembly 520, and third coil assembly 540 are rigidly coupled to the housing 300. Certain embodiments have little to no motion compared to the first and second moving masses 210,220.

The start of the load side/secondary winding 552 wire leads X₁ to first coil assembly 520, then to a center tap/ground/neutral 553 is X₂, then the third coil assembly 540 and back to X₃. The secondary first line voltage 554 is measured between X₁ and X₂, the secondary second line voltage 556 is measured between X₂ and X₃, and the secondary third voltage 556 is measured between X₁ and X₃.

### Three-Phase Transformer

The present disclosure further provides a resonance-enabled three-phase transformer.

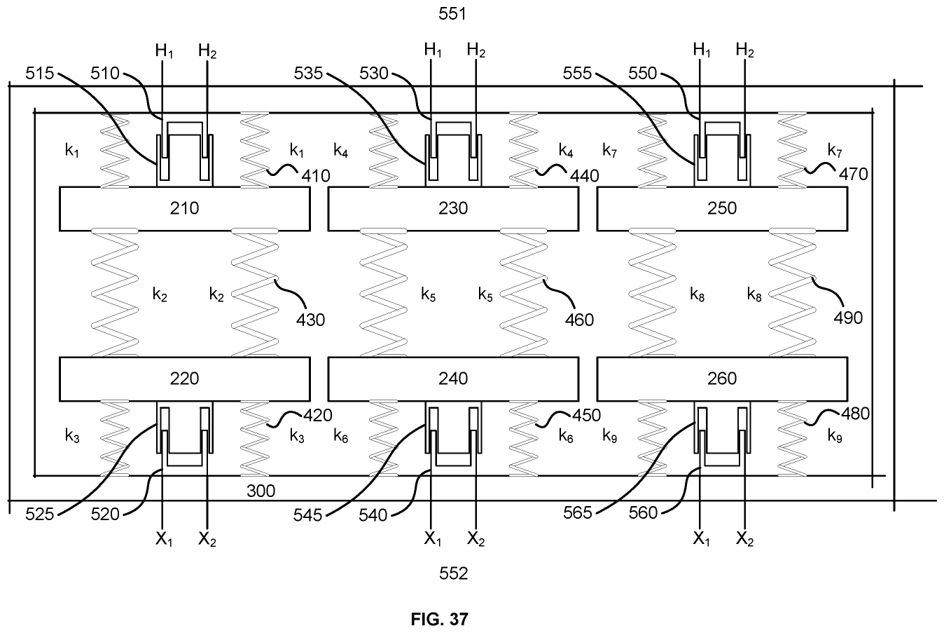

Referring to FIG. 37, the oscillating masses of the resonance-enabled machine move per the resonant mode shape, which is tuned so that the first moving mass 210 is at or near 180° out of phase of the second moving mass 220, the third moving mass 230 is at or near 180° out of phase of the fourth moving mass 240, and the fifth moving mass 250 is at or near 180° out of phase of the six moving mass 260. The input voltage governs the first moving mass 210, the third moving mass 230, and the fifth moving mass 250 vibrational velocity amplitudes. In certain embodiments, the transmitted energy is governed by force on the first moving mass 210, the third moving mass 230, and the fifth moving mass 250, set by the input current.

In certain embodiments, the transformer further comprises a supply side/primary winding 551 with leads H₁ and H₂ and a load side/secondary winding 552. The first moving mass 210 is coupled to the first magnet assemblies 515 and coupled to the housing 300 by a pair of housing-to-first moving mass springs 410, and to the second moving mass 220 by a pair of first moving mass to second moving mass springs 430.

The second moving mass is coupled to the housing 300 via a pair of housing-to-second moving mass springs 420, the first mass 210 by a pair of first moving mass to second moving mass springs 430, and the second magnet assembly 525. In certain embodiments, the first coil assembly 510 and second coil assembly 520 are rigidly coupled to the housing 300 and have little to no motion compared to the first and second moving masses 210, 220.

The third moving mass 230 is coupled to the third magnet assemblies 535 and coupled to the housing 300 by a pair of housing-to-third moving mass springs 440, and to the fourth moving mass 240 by a pair of third moving mass to fourth moving mass springs 460.

The fourth moving mass is coupled to the housing 300 via a pair of housing-to-fourth moving mass springs 450, the third moving mass 230 by a pair of third moving mass to fourth moving mass springs 460, and the fourth magnet assembly 545.

The fifth moving mass 250 is coupled to the sixth magnet assemblies 565 and coupled to the housing 300 by a pair of housing-to-fifth moving mass springs 470, and to the sixth moving mass 260 by a pair of fifth moving mass to sixth moving mass springs 490.

The sixth moving mass 260 is coupled to the housing 300 via a pair of housing-to-sixth moving mass springs 480, to the sixth moving mass 260 by a pair of fifth moving mass to sixth moving mass springs 490, and to the sixth magnet assembly 565.

In certain embodiments, each coil assembly 510, 520, 530, 540, 550, and 560 is rigidly coupled to the housing 300 and has little to no motion compared to the moving masses 210, 220, 230, 240, 250, or 260.

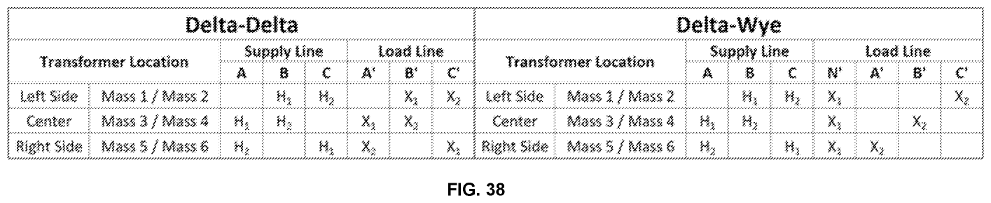

The machine allows both delta-delta and delta-wye transformer configurations, as tabulated in FIG. 38.

### Measurement System

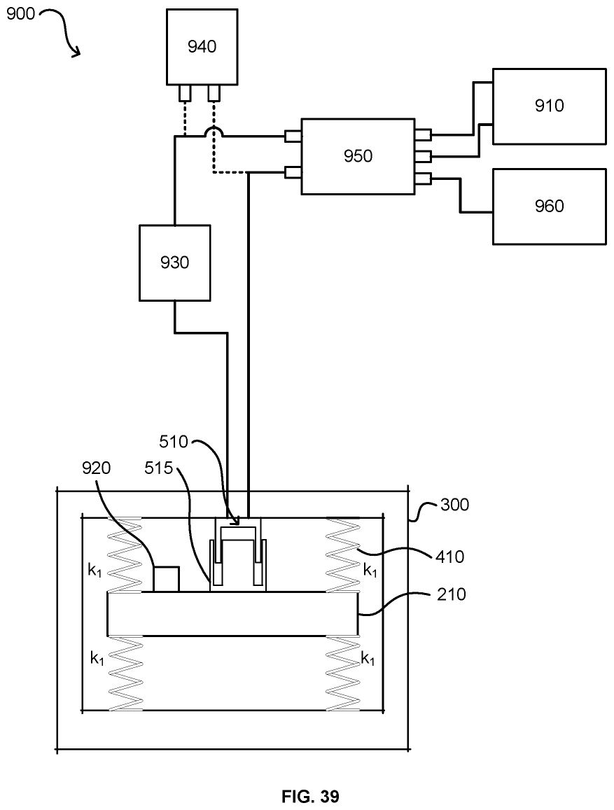

FIG. 39 shows a measurement system 900 connected to a resonance-enabled machine of FIG. 1. The measurement system 900 comprises a power source 910, amplifier 950, function generator 960, voltage sensor 940, current sensor 930, and motion sensor 920. The power source 910 can supply AC or DC voltage. In certain embodiments, the motion sensor 920 measures displacement, velocity, and acceleration. The voltage sensor 940 and current sensor 930 measure the voltage and current driving the resonance-enabled machine. The amplifier 950 takes a power signal, converts it into a driving signal from the function generator 960, and outputs an amplified function. In certain embodiments, the power to drive the system is calculated from the measurements. For example, when the resonance-enabled machine and measurement system are mounted to a concrete pad (6″ thick, 15.2 centimeters thick) and 20′×10′ (3.0 meters×6.1 meters) with k₁ of 4,400 lbf/in (770,558 N/m, total spring rate), the system applied an alternating force of 210 lbf (934 N) at a frequency of 71.5 Hz using less than 50 W.

One of skill in the art can select the number of pairs of moving masses per the needs of electric system or application. Each pair is tuned to be at or near 180° out of phase from each other.

The present disclosures may be understood by reference to the following detailed description, taken in conjunction with the drawings described above. For illustrative clarity, certain elements in various drawings may not be drawn to scale, maybe represented schematically or conceptually, or otherwise may not correspond exactly to certain physical configurations of embodiments.

Although the disclosure described herein is susceptible to various modifications and alternative iterations, specific embodiments thereof have been described in greater detail above. It should be understood that the detailed description of the composition is not intended to limit the disclosure to the specific embodiments disclosed. Rather, it should be understood that the disclosure is intended to cover all modifications, equivalents, and alternatives falling within the disclosure's spirit and scope as defined by the claim language.

When introducing elements of the present disclosure or the embodiments(s) thereof, the articles “a,” “an,” “the,” and “said” are intended to mean that there are one or more of the elements. The terms “comprising,” “including,” and “having” are intended to be inclusive and mean that there may be additional elements other than the listed elements.

All references, patents or applications, US or foreign, cited in the application result from this incorporated by reference as if written herein in their entireties. Where any inconsistencies arise, the material disclosed herein controls.

From the preceding description, one skilled in the art can easily ascertain the essential characteristics of this invention. Without departing from the spirit and scope thereof, one can make various changes and modifications of the invention to adapt it to various usages conditions.

### Examples

Tests were conducted different configurations of the resonance-enabled machine. The parameters are shown on Table 2. The results are shown on Table 3.

TABLE 2
Test parameters

| | Config- | Accelerated | | | | Calculated | | |
|---|---|---|---|---|---|---|---|---|
| Test | uration | 1^{st} or 2^{nd} | Peak | Measured | Measured | Power | Operation | Added |
| number | (FIG.) | moving mass? | Acceleration | Voltage | Current | Draw | Frequency | Weight † |
| 1 | 1 | 1^{st} | 25 g (245 m/s²) | 48 Vrms | 1.0 Arms | 48 Watts | 71.5 Hz | 0 |
| 2 | 1 | 1st | 33 g (324 m/s²) | 39.7 Vrms | 0.4 Arms | 14 Watts | 50.8 Hz | 0 |
| 3 | 1 | 1st | 60 g (588 m/s²) | 40.4 Vrms | 0.6 Arms | 24 Watts | 93.4 Hz | 0 |
| 4 | 1 | 1st | 50 g (490 m/s²) | 40.3 Vrms | 1.4 Arms | 55 Watts | 93.4 Hz | 0 |
| 5 | 24 | 1st | 12.5 g (123 m/s²) | 56 Vrms | 5.0 Arms | 280 Watts | 93.3 Hz | 0 |
| 6 | 24 | 1st | 10 g (98 m/s²) | 56 Vrms | 5.0 Arms | 280 Watts | 93.6 Hz | 0 |
| 7 | 24 | 1st | 5 g (49 m/s²) | 56 Vrms | 5.0 Arms | 280 Watts | 93.6 Hz | 0 |
| 8 | 24 | 1st | 17 g (167 m/s²) | 22 Vrms | 0.3 Arms | 7 Watts | 54.9 Hz | 0 |
| 9 | 24 | 1st | 20 g (196 m/s²) | 41.6 Vrms | 3.8 Arms | 158 Watts | 52.3 Hz | 0 |
| 10 | 24 | 1st | 60 g (588 m/s²) | 66.8 Vrms | 1.6 Arms | 107 Watts | 50.6 Hz | 0 |
| 11 | 25 | 2nd | 40 g (392 m/s²) | 47.1 Vrms | 1.7 Arms | 81 Watts | 72.1 Hz | 0 |
| 12 | 25 | 2nd | 30 g (294 m/s²) | 44.8 Vrms | 1.7 Arms | 76 Watts | 74.4 Hz | 0 |
| 13 | 25 | 2nd | 30 g (294 m/s²) | 47 Vrms | 3.5 Arms | 165 Watts | 76.7 Hz | 200 lb (91 kg) |
| 14 | 25 | 2nd | 30 g (294 m/s²) | 42.8 Vrms | 2.8 Arms | 77 Watts | 47.4 Hz | 0 |
| 15 | 15 | 2nd | 60 g (588 m/s²) | 55.7 Vrms | 2.1 Arms | 117 Watts | 62.5 Hz | 50 lb (23 kg) |
| 16 | 20 | 2nd | 60 g (588 m/s²) | 55.8 Vrms | 2.0 Arms | 112 Watts | 72.1 Hz | 0 |
| 17 | 25* | 2nd | 38 g (373 m/s²) | 51.6 Vrms | 3.0 Arms | 155 Watts | 74.2 Hz | 0 |
| 18 | 25* | 2nd | 28 g (275 m/s²) | 49.9 Vrms | 4.5 Arms | 225 Watts | 77.2 Hz | 200 lb (91 kg) |

Vrms = root mean squared voltage;
Arms = root mean squared amperage;
*Tests 17 and 18 were conducted with the spring-damper 755 mounted rigidly between the tamping plate 650 and the baseplate 740, so that no separation was allowed during oscillation. The other tests above permitted separation.
† When present, the weight was added to the non-moving mass/housing/frame.

TABLE 3
Results

| Test | |
|---|---|
| number | Notes |
| 1 | Hard mounted the tested devices to 6″-thick (15 cm) concrete floor 20′ × 10′ (6 m × |
| | 3 m) minimum size. Shook the building over 1 g (9.8 m/s²) of acceleration |
| | measured on the floor. k₁ = 4400 lbf/in (771 kN/m, total rate) |
| 2 | Operated on a low spring rate (800 lbf/in, 140 kN/m) isolation to ground. |
| 3 | On 4″ (10 cm) of foam, representing very soft soil. k₁ = 13,500 lbf/in (2,364 kN/m, |
| | total rate) |
| 4 | On one layer of foam, representing very soft soil. k₁ = 13,500 lbf/in (2,364 kN/m, |
| | total rate) |
| 5 | Operated with 110 V AC driving a power amplifier, representing medium hardness |
| | soil. K1 = 13,500 lbf/in (2,364 kN/m, total rate) |
| 6 | Operated with 110 V AC driving a power amplifier, representing hard soil. k₁ = |
| | 13,500 lbf/in (2,364 kN/m, total rate) |
| 7 | Operated with 110V AC driving a power amplifier, representing hard soil. k₁ = |
| | 13,500 lbf/in (2,364 kN/m, total rate) |
| 8 | Operated on a low spring rate (<800 lbf/in, <140 kN/m). Operated with a 20 V |
| | RigidTM battery to amplifier to device. |
| 9 | Operation on ground, solid mount, k₁ = 4,400 lbf/in (771 kN/m, total rate) |
| 10 | Operation on ground, solid mount, k₁ = 4,400 lbf/in (771 kN/m, total rate) |
| 11 | Operated with 110 V AC driving a power amplifier on a low spring rate (<800 |
| | lbf/in, <140 kN/m). |
| 12 | Operated with 110 V AC driving a power amplifier on a low spring rate (<800 |
| | lbf/in, <140 kN/m). |
| 13 | Operated with 110 V AC driving a power amplifier on a low spring rate (<800 |
| | lbf/in, <140 kN/m). |
| 14 | Operated with 110 V AC driving a power amplifier on a low spring rate (<800 |
| | lbf/in, <140 kN/m). |
| 15 | Drilled through sandstone (3″, 7.6 cm in 2.5 minutes) with a 1″ (2.5 cm) national |
| | pipe threaded pipe. |
| 16 | Drilled a 3″ (7.6 cm) pipe 12″ (30 cm) into the ground in 10 minutes in |
| | decomposed granite. |
| 17 | Operated with 110 V AC driving a power amplifier with a combined spring rate for |
| | the spring-damper of about 3,500 lbf/in (613 kN/m). |
| 18 | Operated with 110 V AC driving a power amplifier with a combined spring rate for |
| | the spring-damper of about 3,500 lbf/in (613 kN/m). |

1. A resonance-enabled machine, comprising:
one or more voice coil actuators each comprising a coil assembly and a magnet assembly,
a non-moving mass rigidly coupled to the one or more coil assemblies,
one or more moving masses rigidly coupled to the one or more magnet assemblies, and
one or more pluralities of springs coupling the non-moving mass to the one or more moving masses.

2. The machine of claim 1, comprising:
the non-moving mass as a housing;
the one or more voice coil actuators, each comprising a coil assembly rigidly disposed on the non-moving mass and a magnet assembly; and
the one or more moving masses rigidly coupled to the magnet assembly, further coupled to the housing by a plurality of housing-to-moving mass springs, and, when present, further coupled to another of the one or more moving masses by a plurality of moving-mass-to-moving-mass springs.

3. The machine of claim 1, wherein kinetic energy stored in the machine by the one or more moving masses is directly balanced by potential energy stored within the one or more pluralities of springs.

4. The machine of claim 1, wherein forces from the moving masses are transmitted to the non-moving mass, and the transmitted forces within the non-moving mass internally sum to zero or near zero, resulting in a net resulting force amplitude onto the non-moving mass at zero or near zero.

5. The machine of claim 1 operating on a system mode shape using lumped masses.

6. The machine of claim 2, wherein the housing comprises a plurality of plates and a plurality of standoffs.

7. The machine of claim 1, wherein the one or more moving masses comprise a mass assembly comprising a mass plate, a plurality of spacers, and at least one ring.

8. The machine of claim 1, wherein the one or more voice coil actuators comprise a coil assembly, a magnet, and a magnet housing.

9. The machine of claim 1, further comprising one or more selected from the group consisting of a signal generator, oscilloscope, signal conditioner, amplifier, current probe, voltage probe, and accelerometer.

10. The machine of claim 1, having a resonance frequency, and when the machine is in resonance, an input oscillatory force is in phase with an oscillatory velocity of each of the one or two masses.

11. The machine of claim 1 configured to impart forces onto a structure.

12. The machine of claim 1 configured to operate as a vibrator, vacuum pump, compressor, jackhammer, demolition hammer, pile driver, post pounder, hammer, soil compactor, or transformer.

13. The machine of claim 1, wherein the coil assembly of each of the one or more voice coil actuators has little to no motion compared to the one or more moving masses.

14. The machine of claim 12 configured to operate as a vibrator, comprising:
a housing;
a first moving mass coupled to the housing by one or more pluralities of springs;
a coil assembly disposed on and coupled to the housing; and
a voice coil magnet assembly coupled to the first moving mass.

15-18. (canceled)

19. The machine of claim 12 configured to operate as a vacuum pump, comprising:
the non-moving mass as a housing;
one or more voice coil actuators, each comprising a coil assembly rigidly disposed on the housing and a magnet assembly;
a first moving mass rigidly coupled to the magnet assembly, further coupled to the housing by a plurality of housing-to-first moving mass springs;
a second moving mass coupled to the first moving mass by a plurality of first-moving-mass-to-second-moving-mass springs; and
a first pump disposed on the housing and coupled to the first moving mass.

20-22. (canceled)

23. The machine of claim 12 configured to operate as a jackhammer, comprising:
the non-moving mass as a housing;
a voice coil actuator comprising a coil assembly rigidly disposed on the housing and a magnet assembly;
a first moving mass rigidly coupled to the magnet assembly, further coupled to the housing by a plurality of housing-to-first moving mass springs;
a second moving mass coupled to the first moving mass by a plurality of first-moving-mass-to-second-moving-mass springs; and
a hammer chisel rigidly coupled to the first or second moving mass.

24-26. (canceled)

27. The machine of claim 12 configured to operate as a pile driver, comprising:
the non-moving mass as a housing;
a voice coil actuator comprising a coil assembly rigidly disposed on the housing and a magnet assembly;
a first moving mass rigidly coupled to the magnet assembly, further coupled to the housing by a plurality of housing-to-first moving mass springs;
a second moving mass coupled to the first moving mass by a plurality of first-moving-mass-to-second-moving-mass springs; and
an anvil rigidly coupled to the first or second moving mass.

28-30. (canceled)

31. The machine of claim 12 configured to operate as a soil compactor, comprising:
the non-moving mass as a housing;
a voice coil actuator comprising a coil assembly rigidly disposed on the housing and a magnet assembly;
a first moving mass rigidly coupled to the magnet assembly, further coupled to the housing by a plurality of housing-to-first-moving-mass springs;
a second moving mass coupled to the second moving mass by a plurality of first-moving-mass-to-second-moving mass springs; and
a tamping plate rigidly coupled to the first or second moving mass.

32-37. (canceled)

38. A method of measuring soil compaction, comprising:
comparing amplitude measured with a soil compactor of claim 31 against a specified value with an amplitude of unconsolidated soil measured with the soil compactor; and
determining a percentage of soil compaction.

39. The machine of claim 12 configured to operate as a transformer, comprising:
the non-moving mass as a housing;
a first voice coil actuator comprising a first magnet assembly and a first coil assembly rigidly disposed on the housing at a primary winding;
a second coil actuator comprising a second magnet assembly and a second coil assembly rigidly disposed on the housing at a secondary winding;
a first moving mass rigidly coupled to the first magnet assembly, further coupled to the housing by a plurality of housing-to-first moving mass springs; and
a second moving mass coupled to the first moving mass by a plurality of first-moving-mass-to-second-moving-mass springs.

40-49. (canceled)
